(19) United States
(12) Patent Application Publication
(10) Pub. No.: US 2024/0083130 A1
(43) Pub. Date: Mar. 14, 2024

(54) DEWATERING SYSTEM AND METHOD

(71) Applicant: John Christopher Mitchell, League City, TX (US)

(72) Inventor: John Christopher Mitchell, League City, TX (US)

(21) Appl. No.: 17/941,760

(22) Filed: Sep. 9, 2022

(51) Int. Cl. B30B 9/12; B30B 9/14; C02F 11/125

(52) U.S. Cl. CPC B30B 9/121; B30B 9/125; B30B 9/14; C02F 11/125

(57) ABSTRACT

A dewatering system is described having an apparatus with an auger drive and a press container pulled away from a collection hopper in a first type of system. An integration of a press with an automated liquid solid separator using recirculation is a second type of system. An integration of a press with an automated liquid solid separator without recirculation and having drainage to a sewer is a third type of system. A conveyor system integration of press with an automated liquid solid separator with recirculation through use of a sump is a fourth type of system. A conveyor system integration of press with an automated liquid solid separator without recirculation and having drainage to a sewer is a fifth type of dewatering system disclosed herein.

### FIELD OF THE INVENTION

The invention herein described relates to devices for the separation of solids from liquids. More particularly, this invention relates to a dewatering screw press having a rotating screen and an adjustable screw.

### BACKGROUND OF THE INVENTION

Screw presses are commonly used for dewatering applications in industrial and municipal waste water treatment systems. A liquid solid mixture is typically fed to an inlet hopper (to be referred to interchangeably as the collection hopper or hopper for short) where an auger screw located at the bottom of the hopper carries the liquid solid mixture to a permeable cylinder (to be referred to as the cylinder screen or screen or cylinder for short) where the screw is located inside the cylinder screen. The cylinder screen is typically constructed of a metallic slotted screen or cylindrical perforated tube where liquids are able to drain thru small openings to the outside of the cylinder screen and a majority of the solid material remains inside the cylinder. The cylinder screen is usually fixed in place (typically to the hopper structure or otherwise attached to an outside structure that permits the screen to be located in the hopper) and the screw is able to turn via a drive mechanism. The screen may be located in a press container where liquids are collected or it may be exposed with no press container where liquids fall to a collection pan below the screen. As the screw conveys the liquid solid mixture from the hopper into the cylinder screen, free water (or more generally liquids) are able to immediately start draining thru the cylinder screen. This section will be referred to as the free water (or more generally free liquids) drain zone. Water (liquids) absorbed in the solids will remain in the solids (to be referred to as captured water or liquids). At the exit of the cylinder there is typically a restriction that causes the material being conveyed by the screw to compact against the restriction to a pressure sufficient to push the compacted material thru the restricted exit. The area where the material is compacted is the internal space in the cylinder screen from the rotating auger screw tip to the exit of the screen and the restriction or side of the hopper is known herein as the compaction zone. As material reaches the compaction zone, captured liquids continue to squeeze out of the material such that the material that finally exits the auger press has a significant loss of liquid and is relatively dry and is known herein as dewatered solids or cake for short. The liquids drained from the liquid solids mixture (otherwise known as the press filtrate) is collected in a container that is located around or below the cylinder screen and is drained away from the apparatus.

Screw presses are commonly integrated with screening equipment where screening equipment is able to capture and separate solids from liquid solid mixtures, but have no way to dewater the captured solids. When additional wash water is used to clean screens, the captured solids may be in the form of a liquid slurry. It is common for captured solids to a) drop directly into a screw press collector; or b) a liquid slurry could be transported to the screw press collector via piping which could be pumped or conveyed in any manner of known methods.

When looking at a screw press system where distinct (the systems are integrated; however, they may be physically separate or they may be physically bound together as an integral unit) screening equipment is used in the initial step in capturing the liquid solid slurry feed for the press, it is normal to select screening equipment that is capable of capturing the maximum amount of solids from a liquid solid mixture. Metallic wire screens and metallic perforated plate screens have limits to the minimum size openings that are possible to fabricate while keeping structural integrity and also proving sufficient open area for liquids to pass. Alternatively, engineered fabric sieve mesh screens provide excellent non-clogging, high open area for high flow applications with the ability to provide very small openings. Metallic screens are typically referred to as coarse and fine screens depending on the opening sizes and are typically limited to openings of 0.3 mm (0.012 in.) or greater. Engineered fabric mesh screens (referred to often as Microscreens) can vary in opening size anywhere from 0.015 mm (0.0006 in.) to 0.5 mm (0.020 in). Although opening size range for fabric sieves versus metallic screens may overlap, the characteristics are vastly different. For a typical 0.3 mm screen, a metallic wire screen would typically have long slots (surface length) and an open area of approximately 7% depending on construction details (open area is the percentage of open area versus the total area; here one would take the entire surface area of the cylinder as the total area and the open area would be the sum of all slot areas or holes). The same size openings in a fabric mesh would be square mesh openings with an open area of approximately 36%.

This difference results in higher flow and higher capture rates using fabric mesh; as a result, many different types of screening equipment configurations using Microscreens have been developed. Typical configurations would include 1) drum screens; 2) vibratory screens; 3) rotating belt sieve screens; and any other type of screen using a fabric mesh as the filter media. The first of these, a drum screen has the fabric mesh attached to a metal cylindrical screen with some form of screen wash system. A second type known as vibratory screens has a fixed metal screen with fabric mesh attached to the metal screen that vibrates to allow captured solids to vibrate off the screen to be captured. Finally, a rotating belt sieve screens (to be referred to as RBS) typically has an inclined conveyor belt mounted in a container where the conveyor belt is made of the fabric mesh and allows liquids to pass thru while conveying solids to a collection container. RBS systems always have some sort of belt cleaning system and process that is based on water washing, scraping or compressed air removal of the solids affecting the belt. It is very common for RBS Microscreens to have the press hopper integral with the RBS container housing where the press is attached to the RBS container (to be referred to as RBS Microscreen with integral press). In these systems, the belt cleaning system drops solids in the press collector that is integral with the Microscreen container.

However, regardless of which type of Microscreen that is used to capture solids, the moisture content of the solids captured varies depending upon the method and design of the Microscreen. One type of design permits the variation of the moisture content; this adjustment of the moisture content is accomplished through the screw press. The ability to adjust moisture content downwards is ideal for reducing the volume of solids and allows for efficient transportation of solids by reduction of weight and volume.

It should be noted that dried solids may need further processing depending on how solids are to be handled. For solids that are being disposed of, simply transporting solids to a disposal facility may be in accordance with local environmental laws and accepted practices. Other solids may need further processing to improve their reusability or recycling potential, and thusly, additional processes are generally required to meet environmental codes and requirements. For example, pathogens and other harmful elements detrimental to the environment normally need to be removed; also, nutrients beneficial to agricultural applications are normally desired to be preserved. In this manner, solids properly treated can be beneficial for many applications. Whilst this discussion has concentrated on solids in the form of a dried cake undergoing application specific treatment, often it is desirable for solids to be generated in a sludge form to be compatible with many existing sludge treatment processes.

Screw presses used to generate a wet sludge instead of a dry cake may be referred to as sludge thickener or conditioner. Screw presses designed for sludge thickening will commonly have the exit restriction removed and use the auger screw to discharge sludge to an external hopper where sludge is collected, thickened further, or pumped to an additional process. The free water drain section is left intact so the sludge that exits the press is wet but lacks the free water that it had prior to the screw press without the compaction zone (this is known as a sludge conditioner).

Problems˜Basic Screw Press: Screw Presses are susceptible to clogging as material builds up on the cylindrical screen and blocks liquids from draining thru the screen. Also in order for material to continue to move, material must slide on the surface of the screw flights. Material can sometimes stick to the screw flights and can accumulate in such a manner that causes co-rotation where material no longer slides and movement of material is halted. Screw speed, restriction pressure, and screen cleanliness are all factors that can lead to problems such as clogging, co-rotation and possibly jamming the press. Most screw presses are equipped with cleaning devices to consistently keep screen openings clear. These cleaning devices will commonly be able to rotate around the stationary cylinder screen and can include high pressure water wash, steam injection, and brushes to clean the outside of the cylinder screen in addition to brushes attached to the flight tips themselves to clean the inside of the cylindrical screen. Other presses will monitor the outlet restriction pressure and vary screw speed based on pressure in order to prevent co-rotation. However, these types of systems quickly become complex and are expensive to build, maintain and repair.

Problems˜Microscreen Feeding Press/Sludge Conditioner: Sludge Moisture content from a sludge conditioner is typically uncontrolled and is a function of the application and the Microscreen design and type. For example, a RBS Microscreen using belt cleaning processes that does not use water creates a dryer sludge and RBS that do use water to clean the belt will generate a wetter sludge. Also, the concentration of solids removed from the Microscreen will also have a dramatic effect on sludge moisture content. Many processes for sludge treatment will require a moisture range required for either pumping the sludge or to processing of the sludge.

Issues˜Screw Presses Dewatering: Screw Presses are commonly used in sludge dewatering plants to dewater processed sludge. Typically, upon entering the screw press processed sludge has already been thru processes that have removed harmful contaminants and may have beneficial properties depending on the type of processing performed. Usually the sludge then needs to be dewatered so it can be more easily transported, disposed of or sold as a commodity. Processed sludge is generally a challenge to dewater because it has already been broken down into very small particles and screening and pressing becomes difficult. There are limitations on using a screw press for dewatering because as previously mentioned there are limitations on the openings in the cylinder screen size. As dewatering requires high pressure, fabric mesh use is limited in this application because of its lack of structural integrity. It is common for solids that are being compressed to extrude thru the wire openings. In order to reduce this, expensive chemical conditioning is common which adds coagulants or chemical polymers into the sludge to enhance its dewatering capability by enhancing its ability to stick together to be captured and pressed.

Thus, a solution is needed that uses a screw press that improves on conventional cleaning systems by simplifying the cleaning process so that the press is smaller and more economical. Additionally, there is a need for a screw press that adds flexibility to the cake/sludge moisture content by use of simple mechanical features that eliminates the need for complex speed controls and measuring instruments. Also, there is a need for a robust press design that avoids, jamming, co-rotation and clogging. Also, there is a need for a dewatering system that is capable of reducing the need for chemical conditioning by either reducing chemical demand or completely eliminating it.

Problems˜Co-Rotation: Another issue with screw presses is the issue with co-rotation where material sticks to the auger flights and rotates with the screw and then is no longer capable of moving. This is a common known problem when using a screw that has a shaft. In order for material to move, the material needs to slide along the bottom of the trough or cylinder screen. If you are moving sticky material and too much material accumulates and presses against the shaft and the flights, it can become wedged and pressed into place causing the condition for co-rotation. Additionally, the prior art teaches cylinder screens that are designed to rotate for cleaning purposes. Also known are shaft-less screws commonly used for their ability to resist co-rotation but these are not ideal for pressing applications. Thus, there needs to be a solution that resolves the issue of co-rotation.

Problems˜Chemical Treatments+There are a lot of press designs where screen openings are minimized to achieve the highest capture rates. This is common in dewatering plants after sludge has been processed and the water needs to be removed for transportation or disposal. These systems are typical in a single pass system. Multiple pass systems don't increase efficiency of capture solids if the recycle is going to the same size screen. In these applications it is common for chemical treatment of the sludge to enhance the sludge's ability to be dewatered. Chemical treatment will usually make the sludge stick together so that free water can be drained without solids going thru screen openings. Thus, there needs to be a solution that resolves this issue.

### SUMMARY OF THE INVENTION

The present invention overcomes the deficiencies of the known art and the problems that remain unsolved by providing:

A dewatering system comprising:
a collection hopper receiving a liquid solid mixture wherein the collection hopper has a screw inserted within a bottom portion thereof, wherein the bottom portion forms a trough;
a first motor external to collection hopper actuating the screw; wherein the screw conveys material to a cylindrical screen disposed within an adjacent press container;
a screw tip is attached to the screw at a connection such that the screw tip terminates inside of the cylindrical screen at an adjustable location in an axial direction within the cylindrical screen; wherein the connection permits adjustments in an overall length of the screw and screw tip thereby changing a size of a compaction zone within the cylindrical screen;
a set of rollers supporting the cylindrical screen, wherein the rollers are attached to the adjacent press container such that the rollers permit rotation of the cylindrical screen but forbids motion longitudinally or laterally;
a second motor supported on top of the press container such that the second drive is rotationally coupled to the cylindrical screen; and
a first speed controller associated with the cylindrical screen capable of varying the speed of the cylindrical screen.

In another aspect, further comprising:
a stationary brush attached to the press container such that the stationary brush comes into contact with a surface of the cylinder screen defined by an outside diameter thereof in order to remove excess solids from the outside diameter.

In another aspect, further comprising:
a stationary brush bracket for mounting the stationary brush such that the stationary brush bracket is bolted to the outside of the press container and protrudes inside the container thru holes in the press container so that the stationary brush can be replaced with minimal disassembly.

In another aspect, further comprising:
a stationary spray wash located on the outside of the cylinder screen in association with the press container in order to remove excess solids from the outside diameter.

In another aspect, further comprising:
an outlet restriction at an exit of the press container that generates a dry cake.

In another aspect, further comprising:
one or more brushes on an auger flight of the screw tip thereby cleaning an inside diameter of the cylindrical screen.

In another aspect, further comprising:
an automated liquid solid separator deposits screened solids and any wash water associated therewith to the collection hopper;
a press filtrate sump associated with a drain of the press container;
a pump that is able to pump liquids from the sump through appropriate connection there between;
a sump level detector that sends signals to a controller capable of turning the pump on and off, wherein the pump is turned on when a high liquid level in the sump is detected and is turned off when low liquid level in the sump is detected;
wherein the pump when activated moves press filtrate back to the automated liquid solid separator through appropriate connection there between in order to be screened again.

In another aspect, further comprising: where the automated screen system is located above the dewatering device and feeds directly into the hopper by gravity.

In another aspect, further comprising:
where the automated screen system discharges a liquid solid mixture to a conveyor system that conveys the mixture to a location above the dewatering device and feeds directly into the hopper.

In another aspect, further comprising, a second speed controller associated with auger screw capable of varying the speed of the auger screw.

A dewatering system comprising:
a first motor associated with
a press container having a first motor actuated rotating cylinder screen therein, such that the press container is attached to
a hopper associated with the press container, and a second motor associated with the hopper, wherein the hopper has a second motor actuated auger screw rotationally mounted therein; wherein liquid solid materials arrive in the hopper and are processed thereby and then transported to the press container by motion of the auger screw for further processing by the rotating cylinder screen;
an automated liquid solid separator associated with the hopper such that the hopper receives liquid solid materials from the automated liquid solid separator.

In another aspect, further comprising:
a sump receiving processed effluents from a drain in the press container and recirculating the processed effluents through the automated liquid solid separator.

In another aspect, further comprising:
a pump attached to the sump whereby the processed effluents are pumped to the automated liquid solid separator.

In another aspect, further comprising:
influent raw liquid enters the automated liquid solid separator such that an effluent screened liquid exits directly therefrom.

In another aspect, further comprising:
wherein the liquid solid materials arriving in the hopper are processed thereby and transported to the press container by motion of the auger screw for further processing by the rotating cylinder screen such that liquids exit a drain in the press container to a sewer.

In another aspect, further comprising:
cake produced by the press container rotating cylinder screen from the liquid solid materials arriving in the hopper and processed thereby that have been transported to the press container by motion of the auger screw for further processing by the rotating cylinder screen, wherein the cake exits an opening in the press container.

In another aspect, further comprising:
a conveyor disposed between the automated liquid solid separator and the hopper such that conveyor transports wet solid materials above the hopper for placement therein.

In another aspect, further comprising:
a drain in the press container attached to a sump, wherein the exiting liquid solid materials are transported to the sump;
a pump attached to the sump whereby the exiting liquid solid materials are transported to the automated liquid solid separator.

In another aspect, further comprising:
a drain in the press container associated with a sewer, wherein the exiting liquid solid materials are released into the sewer.

In another aspect, further comprising: a first variable frequency drive associated with the first motor capable of varying the speed of the motor and the direction of the motor.

In another aspect, further comprising: a second variable frequency drive associated with the second motor capable of varying the speed of the motor and the direction of the motor.

A dewatering system comprising:
a first motor associated with
a press container having a first motor actuated rotating cylinder screen therein, such that the press container is attached to a last hopper;
a first hopper associated with the press container, and a second motor associated with the first hopper, wherein the first hopper has a second motor actuated first auger screw rotationally mounted therein; wherein liquid solid materials arrive in the first hopper and are processed thereby and then transported to the press container by motion of the auger screw for further processing by the rotating cylinder screen;
one or more other auger screws connected sequentially to the first auger screw wherein the one or more other auger screws are each situated within a single one of one or more other hoppers attached together sequentially; and
an auger tip attached to a last auger screw in the sequence wherein the auger tip is situated in the last hopper, such that there is at least one more sequentially attached hoppers than their are auger screws as the last hopper hosts the auger tip.

These and other aspects, features, and advantages of the present invention will become more readily apparent from the attached drawings and the following detailed description of the preferred embodiments.

### BRIEF DESCRIPTION OF THE DRAWINGS

The preferred embodiments of the invention will hereinafter be described in conjunction with the appended drawings provided to illustrate and not to limit the invention, in which:

FIG. 1A presents an isometric exploded view of a Dewatering System having an auger drive and a press container pulled away from a collection hopper in a first embodiment disclosed herein.

FIG. 1B presents a cross (front) side view of a Dewatering System hopper in a first embodiment disclosed herein.

FIG. 1C presents a front side view of the auger drive assembly in a first embodiment described herein.

FIG. 1D presents an isometric view of the auger drive assembly in a first embodiment described herein.

FIG. 1E presents an exploded assembly isometric view of the auger drive assembly showing the various components in a first embodiment disclosed herein.

FIG. 2A presents a side section view of that shown in FIG. 1A in a first embodiment disclosed herein of a Dewatering System.

FIG. 2B presents a closeup view of a portion of the left side of the view shown in FIG. 2A in a first embodiment disclosed herein of a Dewatering System.

FIG. 2C presents a closeup view of a portion of the right side of the view shown in FIG. 2A in a first embodiment disclosed herein of a Dewatering System.

FIG. 2D presents a modified side section view having a multi-auger screw connection/multi-hopper in a second embodiment disclosed herein of a Dewatering System.

FIG. 3A presents a cross section view of the press container with internals (container side walls removed for clarity) in a first embodiment disclosed herein of a Dewatering System.

FIG. 3B presents a front section view of the section line in FIG. 3A of the press container in a first embodiment disclosed herein of a Dewatering System.

FIG. 3C presents an isometric view of the press container 10 with the cylindrical screen drive assembly installed.

FIG. 3D presents an isometric exploded view of the press container 10 with press container 10 box and spray wand pulled away from the internal components in a first embodiment disclosed herein.

FIG. 3E presents an isometric exploded view of press internals in a first embodiment disclosed herein.

FIG. 3F presents an isometric view of the screen motor support 54 and bracket 53 with the cylinder screen drive assembly and support bearing mounted thereon in a first embodiment disclosed herein

FIG. 3G presents an exploded assembly view of FIG. 3F in a first embodiment disclosed herein.

FIG. 3H presents an isometric exploded view of the screen motor support 54 and bracket 53 with the cylinder screen drive assembly and support bearing omitted in a first embodiment disclosed herein.

FIG. 4A presents a side view of a completed cylinder screen assembly in a first embodiment disclosed herein of a Dewatering System.

FIG. 4B presents an isometric view of a completed cylinder screen assembly in a first embodiment disclosed herein of a Dewatering System.

FIG. 4C presents an isometric exploded components assembly view of a cylinder screen assembly in a first embodiment disclosed herein of a Dewatering System.

FIG. 5A presents a side view of an auger screw assembly in a first embodiment disclosed herein of a Dewatering System.

FIG. 5B presents an disassembled side view of an auger screw assembly in a first embodiment disclosed herein of a Dewatering System.

FIG. 5C presents a side view of an auger tip section in a first embodiment disclosed herein of a Dewatering System.

FIG. 6A presents a schematic of an integration of a press with an automated liquid solid separator using recirculation in a third embodiment disclosed herein of a Dewatering System.

FIG. 6B presents a schematic of integration of a press with an automated liquid solid separator without recirculation and having drainage to a sewer in a fourth embodiment disclosed herein of a Dewatering System.

FIG. 6C presents a schematic of a conveyor system integration of a press with an automated liquid solid separator with recirculation through use of a sump in a fifth embodiment disclosed herein of a Dewatering System.

FIG. 6D presents a schematic of a conveyor system integration of a press with an automated liquid solid separator without recirculation and having drainage to a sewer in a sixth embodiment disclosed herein of a Dewatering System.

FIG. 7 presents a view of the electronic controls useable in the first to sixth embodiments disclosed herein of a Dewatering System.

FIG. 8 presents a flowchart of the operational control of a Dewatering System in any of the embodiments disclosed herein.

Like reference numerals refer to like parts throughout the several views of the drawings.

### DETAILED DESCRIPTION

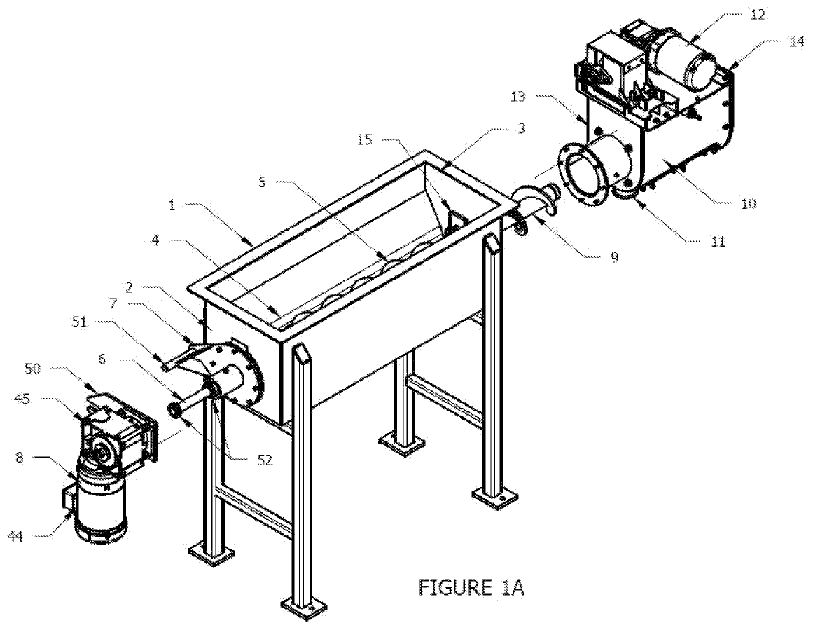

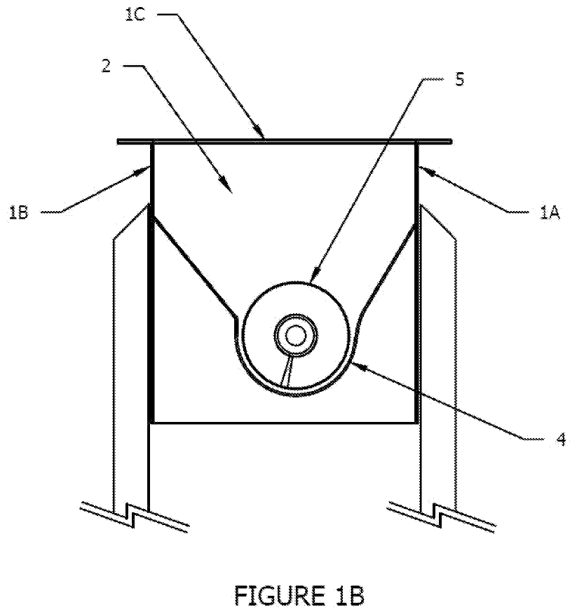

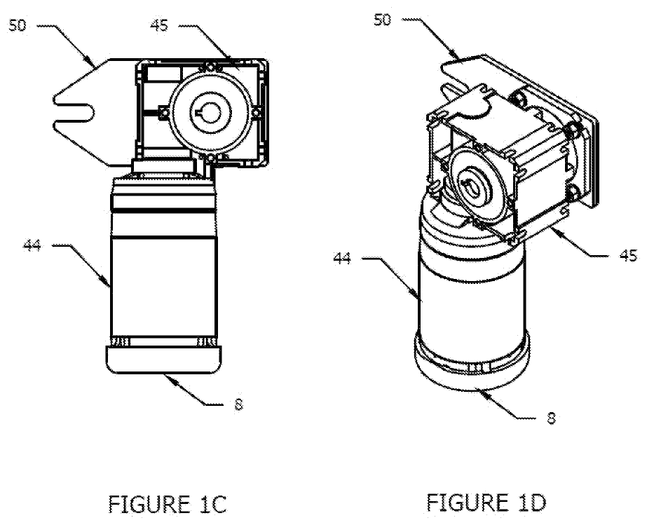

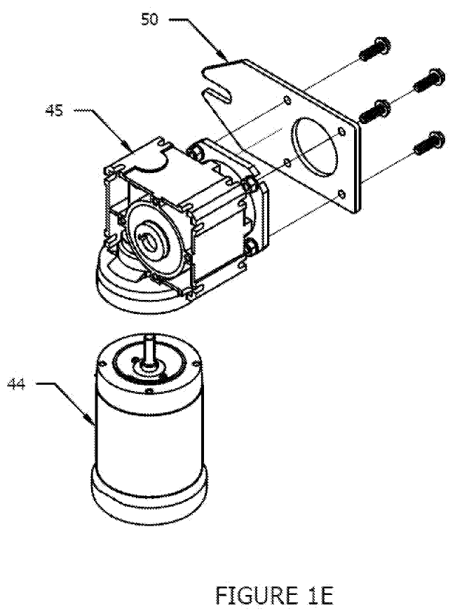

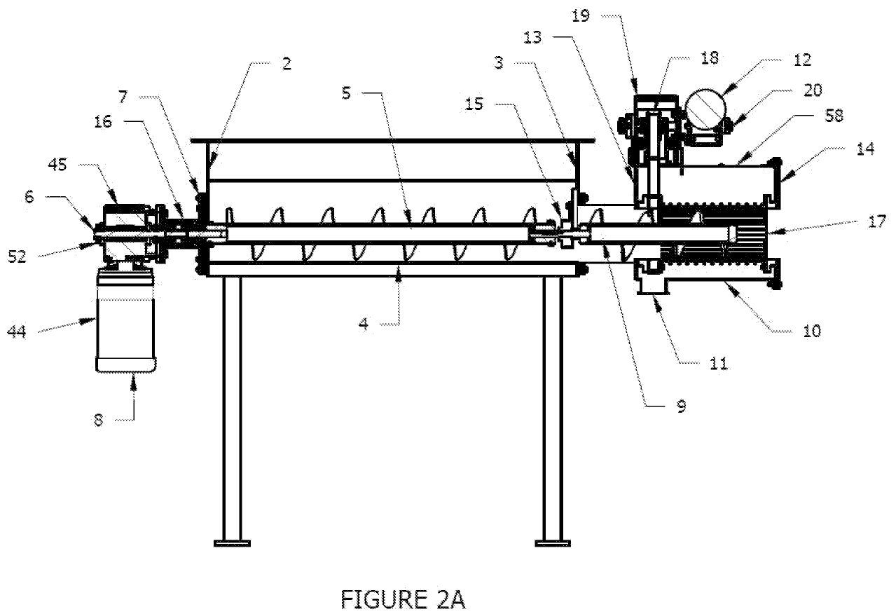

The following detailed description is merely exemplary in nature and is not intended to limit the described embodiments or the application and uses of the described embodiments. As used herein, the word exemplary or illustrative means serving as an example, instance, or illustration. Any implementation described herein as exemplary or illustrative is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms upper, lower, left, rear, right, front, vertical, horizontal, and derivatives thereof shall relate to the invention as oriented firstly with respect to FIG. 1 as applied to each figure or alternatively as needed based on the requirements of each figure.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

General Description

A liquid solid mixture enters the press thru the collection hopper 1. Walls are sloped into an inner portion of the hopper 1 shaped as a trough 4 so liquid—solid debris that falls therein slide down to the center where a first auger screw 5 carries the liquid solid mixture towards a cylindrical screen 17 (or cylinder screen) located in an adjacent press container 10; it is driven by a cylinder screen drive assembly 12 mounted atop the press container 10. The auger screw 5 is driven by an external auger drive assembly 8 located outside the collection hopper 1. The auger screw 5 is supported by the collection hopper 1 with bearings on the front 2 and rear wall 3. Bearings on the front wall 2 are located outside the hopper 1 and have a seal between bearings and the inside of the collection hopper 1 to prevent liquids from leaking out therefrom. An auger tip (or second auger screw) is rigidly connected to the first auger 5 screw at the rear of the collection hopper 1 where the hanger bearing located on the rear wall 3 is located. It should be noted that multiple collection hoppers 1 could be present in which case there would be multiple augers and a hanger bearing 15 provided at each adjacent wall of the multiple collection hoppers. The final auger screw is called the auger tip 9.

The auger tip 9 is supported at the hanger bearing 15 on the collection hopper 1 (or last hopper for multi-stage) rear wall and is cantilevered into the cylindrical screen 17 (shown in other figures) located in the press container 10; it should be noted that the auger tip 9 ends prior to the end of the cylindrical screen 17. The portion of the cylindrical screen 17 where the auger tip 9 (or auger screw tip) is present is called the free drain zone. The portion of the cylindrical screen 17 where the auger tip 9 has ended (a void section after the screw) is called the compaction zone. At the exit of the cylindrical screen 17 is an optional restriction; this restriction can be any configuration that limits the available area for the solid cake to discharge. A common restriction would be a spring loaded door that generates more force as the door is opened wider. Other devices could include a hydraulic cone that adjust position based on measured pressure, a fixed reduction such a concentric pipe reducer or any other means commonly known. When the desired output is a dry cake, a restriction is necessary to increase pressure in the compaction zone to the highest pressure possible to achieve the desired moisture content of the cake.

Typical dry solids ratio for mechanical dewatering (meaning a mechanical squeezing process) is typically 15-40% dry solids content. When a sludge is required at the output then the typical moisture range is typically 1-4% dry solids content. This is a range compatible with many processes and still allows the sludge to be handled like a liquid. In this range, sludge can be pumped and will gravity flow thru additional processes. In order to achieve proper moisture content for a specified sludge range, the exit restriction on the press needs to be very low; typically the exit restriction is completely omitted for this reason. It should be noted that the exit restriction can be designed to attach to the rear wall of the press container so removing the exit restriction can be as easy as simply unbolting the apparatus. Once the restriction is removed, it is necessary to determine what the moisture content is for the sludge that exits the press.

The free drain zone and compaction zone are found within the press container 10. Free water exits through a drain 11 integrally formed or attached to a bottom portion of press container 10 in the free water drain zone; also, once any material reaches the compaction zone it accumulates there. But with no exit restriction, the material being fed to the compaction zone only needs to push the volume of material in the compaction zone out the exit. The larger the volume moved through the compaction zone, the more the weight and thus the friction increases of the material occupying the compaction zone. In this regard, the volume of material in the compaction zone becomes the restriction for the press by applying a back pressure equal to the pressure required to move the material in the compaction zone. When generating sludge, it is necessary to select the correct small back pressure to achieve the proper moisture range. Here, this can be achieved by either increasing or decreasing the size of the compaction zone so that the solids exiting will have the proper moisture content. Adjustability of the screw length at the point where the auger tip is attached to the previous auger section allows for the screw overall length to be adjusted without causing fitment problems in the collection hopper. Since the hanger bearing in the collection hopper 1 is fixed, moving the entire screw is not a viable option. This problem is solved by having a male/female connections where the male has multiple longitudinal set points so the screw cantilever distance can be adjusted to achieve the optimal compaction zone distance.

Another novel concept herein taught utilizes the cylinder screen's ability to rotate independently of the screw to reduce co-rotation issues which means the cylinder screen is typically always rotating at some specific speed during operation. By rotating the cylinder screen (or cylindrical screen interchangeably), prevention of the material in the screen from accumulating on the bottom of a stationary screen is possible. By using a variable speed controller adjustments can be made to the speed to find the optimum speed to minimize co-rotation. By rotating the cylinder screen in the same direction as the auger screw but at a slower speed, the equivalent of a slower auger screw is achieved while the feed rate of solids from the collection hopper 1 remain the same. By rotating the auger screw in the opposite direction the teachings herein can speed up the auger screw tip while maintaining the same feed rate. By having cleaning attachments such as an external spray header and an external stationary brush, these can effectively clean in place the openings in the cylinder screen while the press is in operation. This keeps the free water flowing thru the screen and avoids excessive liquids in the press which can also prevent solids from moving thru the press. By rotating the cylinder screen instead of the cleaning devices, the press design herein taught effectively eliminates complex rotating systems that can now be fit into a much more compact area.

In a further improvement to the prior art, a novel dewatering press is coupled to an automated screening machine (an automated liquid solid separator) using mesh with openings less than the cylindrical screen, usually 300 microns (0.012 in.) or smaller where the press filtrate is fed back to the separate screening machine to be called an automated liquid solid separator for clarity. This solves the problem of making the press design much simpler. Wire screen openings become less important because material that squeezes thru the openings is captured in the automated liquid solid separator when recycled. Chemical treatment requirements when using an automated liquid solid separator is reduced because the automated liquid solid separator screening step has higher capture rates than the cylindrical screen in the present invention. Since the press filtrate is no longer the final liquid product of the system, it is possible to continuously recycle the liquids until all solids have been screened out at the smaller openings of the automated liquid solid separator while continuously being able to dewater the solids either to a sludge in the target moisture range or to a cake in the target moisture range.

For the purposes of this disclosure the term: “an automated liquid solid separator” is described as a liquid solid separator using a screen or fabric mesh that utilizes one or more types of separator systems or combinations of diverse systems such as: 1) a drum screen; 2) a vibratory screen; 3) a rotating belt sieve screens; and 4) any other type of screen using a fabric mesh as the filter media. Here the screen fabric mesh or filter media would be from 20-300 microns.

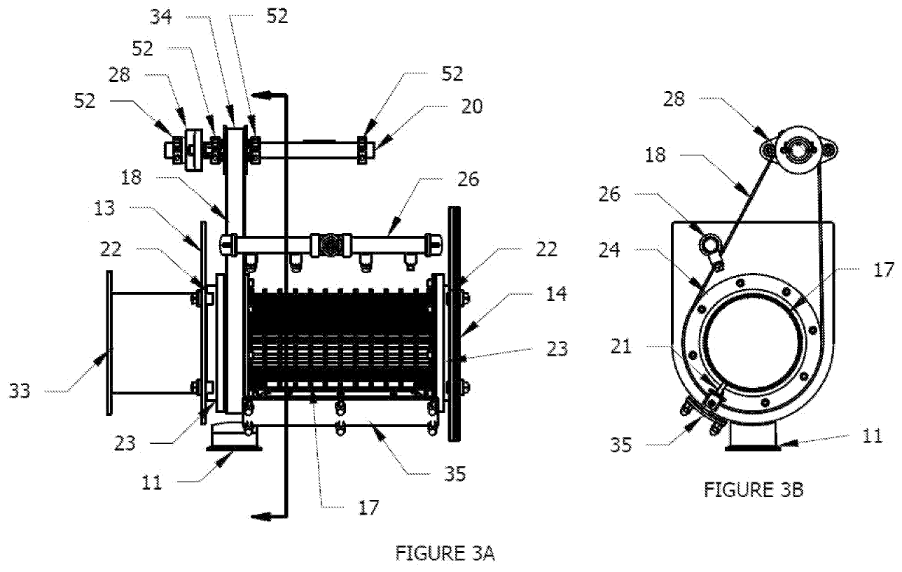

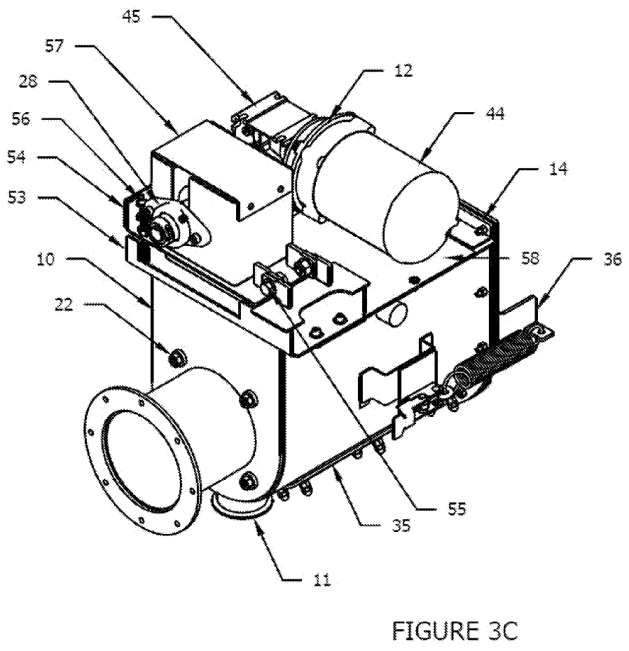

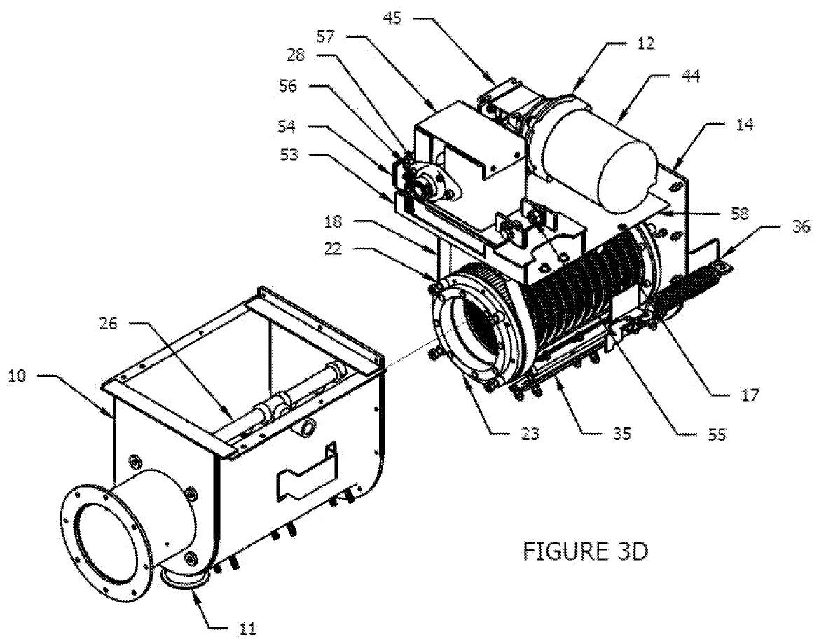

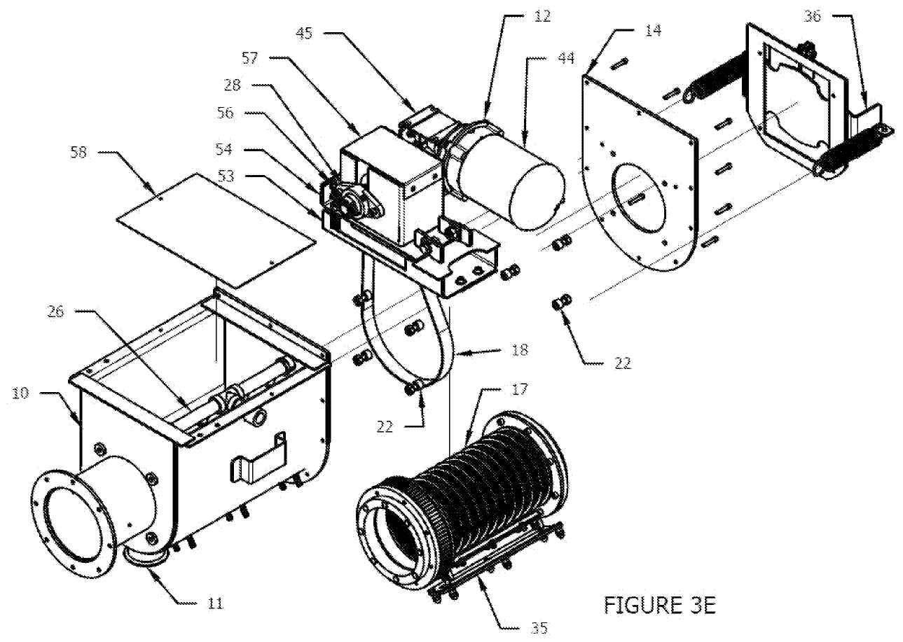

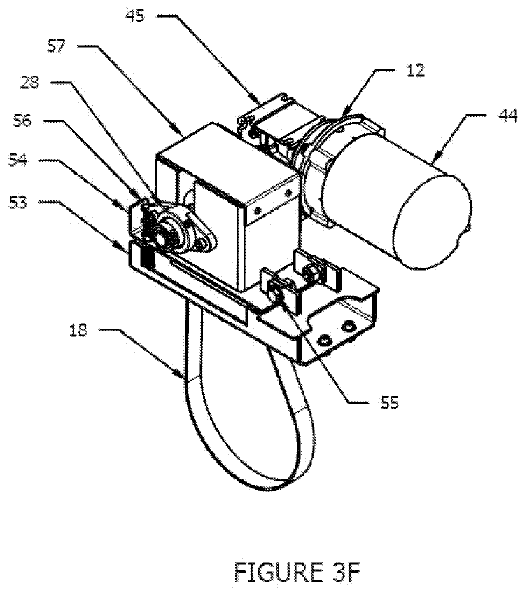

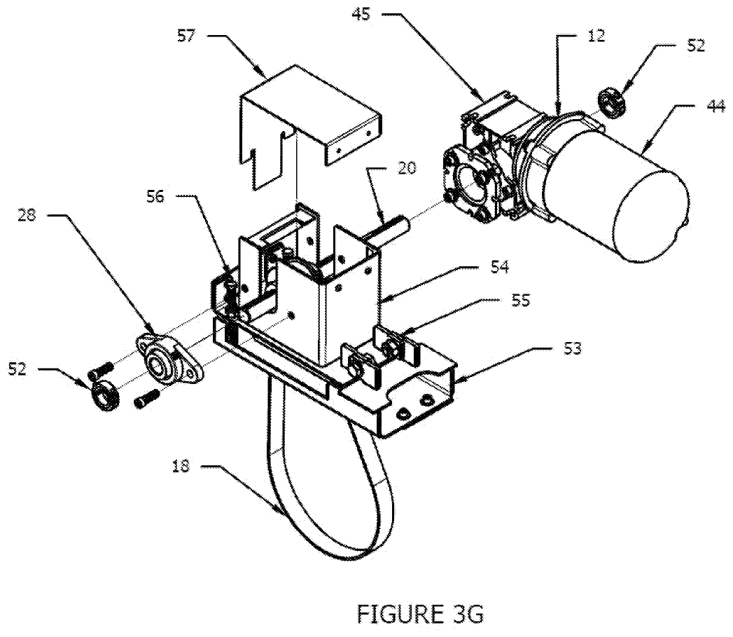

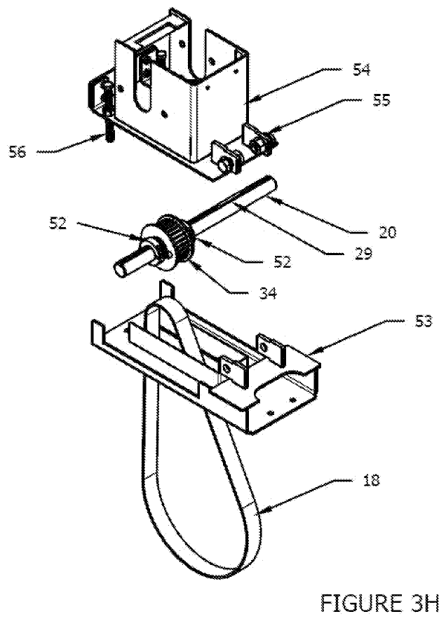

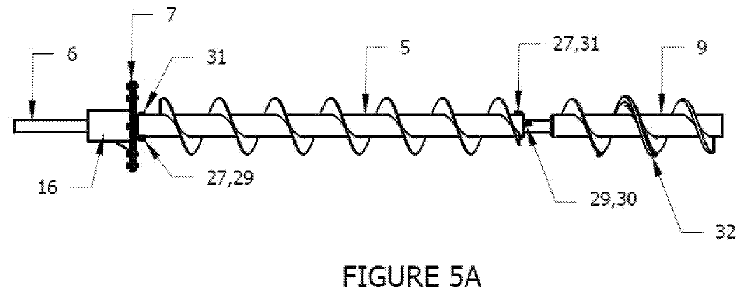

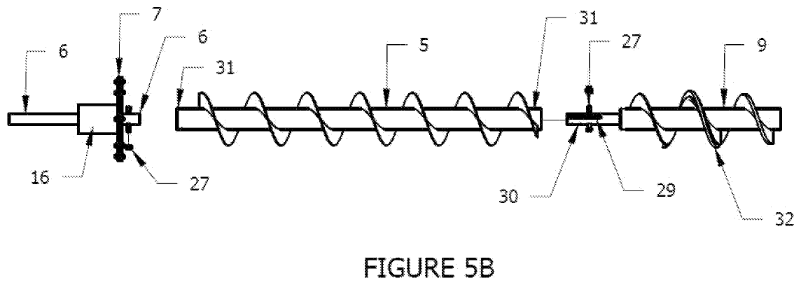

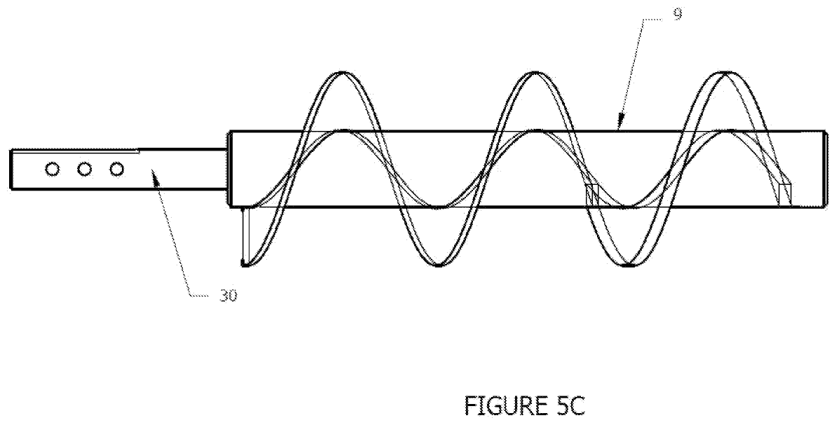

FIG. 1A, 1B, 1C, 1D, 1E, 2A, 2B, 2C and FIG. 3A—FIG. 5C inclusive of the intervening figures are common components of the first embodiment and the other embodiments unless specifically excluded or modified within a particular other embodiment.

FIG. 1A presents an isometric exploded view of a Dewatering System with an auger drive assembly 8 and a press container 10 pulled away from a collection hopper 1 in a first embodiment disclosed herein. In FIG. 1A, the collection hopper 1 (or hopper used interchangeably), receives a liquid solid mixture from the top side of the hopper. The hopper may have an open top or may be fitted with an optional cover that interfaces with an inlet duct or pipe. The hopper 1 is formed as a rectangular container having right and left longitudinal sides interconnected by welds with two transverse short front (at lower left) and rear (at upper right) walls (or sides); these are all interconnected with a bottom side as appropriate (typically welded). The hopper 1 has four legs welded or otherwise attached to the outer portions of right and left longitudinal sides as viewed in the drawing of the hopper 1 with two sets of two legs, one set near the front of the hopper 1 and the other set near the rear of the hopper 1. Further, each set of legs has a pair of transverse connectors welded to the two legs of the same set where the transverse connectors are parallel to one another for each set. The right and left longitudinal sides of collection hopper 1 have respective right 1A and left inner surfaces 1B of the hopper 1.

Thus, the inner portion of the collection hopper 1 is formed into a collection hopper trough 4 with a round bottom portion that is formed so that an auger screw 5 is longitudinally disposed therein from a front wall 2 (at left in the figure) of the hopper 1 trough 4 to the rear wall 3 thereof (at right in the figure); there is only a small clearance between the auger screw 5 and the round bottom portion of trough 4 so that material is capable of being conveyed by the auger screw 5. The collection hopper 1 trough 4 has respective right 1A and left 1B inner surfaces from the top thereof to the bottom side of the hopper 1 integrally formed, welded or attached together. Internally there is a single piece of material forming two opposing sloping portions and a round bottom portion. The respective right 1A and left 1B inner surfaces are also attached or welded respectively to a single separate sloping portion's top longitudinal edge; thus, a right inner surface 1A is to one sloping portion top edge; and the left inner surface 1B is attached to the other sloping portion top edge. Further, the front edge of the single piece of material is attached or welded to the inner front surface of the front wall 2 and the rear edge of the single piece of material is attached or welded to the inner rear surface of the rear wall 3. Two sloping portions and a round bottom portion of trough 4 are formed from a single piece of material more clearly described with respect to FIG. 1B so that material entering the hopper 1 falls onto the sloping portions (or directly towards the round bottom portion and auger screw 5) of the single piece of material forming the trough 4 until reaching a round bottom portion of trough 4 which is subsequently acted on by the auger screw 5 (interchangeably auger screw, auger or screw).

The collection hopper 1 rear side at top right is a rear wall 3 having an open hole where the auger screw 5 ends and there is a rigid connection to an auger tip 9. The two auger sections 5, 9 are supported by a hanger bearing 15 that is rigidly connected to the hopper rear wall 3 (it is associated with the hole or opening therein) and cantilevers so that the bearing centerline is in-line with the auger centerline; more connection details are to be covered in other figures. The press container 10 is bolted or welded to the collection hopper 1 rear wall 3 and has an auger screw tip zone formed by a tubular structure 33 that protrudes into the press container (and is welded or bolted thereto) and protrudes out from the press container 10; this tubular structure 33 ends in a circular flanged end that is bolted or welded to the rear wall 3 of the hopper 1.

In this view, the auger screw 5 conveys material from the inner portion of front wall 2 to the rear press container wall 14. The auger drive shaft 6 attaches to the auger screw 5 and also supports the auger drive assembly 8. The auger screw drive assembly 8 (most generally a motor) is supported from the drive shaft 6 and is attached directly to the auger screw support flange 7 and bearing housing 16. When the auger drive assembly is mounted to the shaft 6, the auger drive assembly is rigidly attached to a separate mounting plate 50 that has an integral torque arm. The torque arm interacts with an integral torque pin 51 on the mounting support flange 7 and bearing housing 16 to prevent rotational movement. Additionally, two shaft collars mounted on shaft 6 assist in controlling the position of the auger screw drive assembly on the shaft 6. Alternatively, when mounted directly to the support flange 7 and bearing housing 16 (unit), the auger drive assembly 8 is attached rigidly with fasteners to a fixed mounting plate attached to the screw support flange 7 and bearing housing 16. It should be apparent that the auger screw support flange 7 and bearing housing 16 has a series of holes in the flange for bolt screw attachment to the hopper front wall 2.

FIG. 1A also shows mounting plate 50 with integral torque arm, an integral torque pin 51 on the support flange 7 and bearing housing 16, and shaft collars 52 on auger screw 6 as well as motor 44 and mechanical gear reducer 45. The auger drive assembly 8 comprises generally: the mounting plate 50, the gear reducer 45 and motor 44 (and other necessary components components) in this exemplary description. The mounting plate 50 is attached appropriately to the mechanical gear reducer 45 which in its turn is also attached to the motor 44. First and second shaft collars 52 are attached appropriately to a portion of the auger screw drive shaft 6 externally to the collection hopper 1 for positioning of the auger screw drive assembly there between. Another portion of the screw drive shaft 6 is inserted within an opening in the support flange 7 and bearing housing 16 and therethrough into the collection hopper 1 interior. The auger screw drive shaft 6 is itself attached through mounting plate 50 to the mechanical gear reducer 45 and through that connected to motor 44. It should be understood that auger screw drive assembly 8 is most generally a motor 44 but has other equipment such as the aforementioned as needed and these are optionally removed as desired. For example, the motor 44 can be directly attached to the auger screw drive shaft 6 without intervening components as long as the motor is appropriately designed.

The press container 10 has a drain 11 located on the bottom of the press container 10. On top of the press container 10 a cylinder screen drive assembly 12 is supported from the top of the press container 10. The cylinder screen drive assembly 12 (most generally a motor and speed controller) has the ability to either rotate the screen or prevent the screen from rotation either thru a brake system or by having gears arranged in such a manner that only an activated drive will allow the cylinder to rotate. Material enters the press container 10 thru a hole or port on the front press container wall 13 and leaves the press thru a hole or port on the press container rear wall 14. This hole or port on the front press container wall 13 is associated with the auger screw tip section tubular structure that protrudes into the press container 10 and is attached internally thereto; this tubular structure is also welded to the front wall 13 and protrudes out from the press container 10 ending in a circular flanged end that is bolted to the rear wall 3 of the hopper 1. It should be appreciated that the press container 10 has a press container rear wall 14 welded or bolted to the central body of the press container 10 which is a U-shaped enclosed box structure. This enclosed box structure is attached by the circular flanged end of the tubular structure to the front press container wall 13.

FIG. 1B presents a cross (front) side view of a Dewatering System collection hopper 1 in a first embodiment disclosed herein. Here an auger screw 5 is placed within a round bottom portion of the trough 4 and is accessible by a shaft 6 placed into an opening in the support flange 7 and bearing housing 16 (not shown) that has been mounted in the front wall 2 of the hopper 1. The trough sloping portions and bottom portion are formed from a single piece of material having four sides and respective edges thereof (front, rear and two longitudinal sides, edges). The single piece of material forming the trough 4 is bent and shaped with machinery so as to form a round bottom portion between two angled sloping portions; the shape and positioning of the sloping portions down towards the bottom portion facilitates gravity motion of material down into the trough 4 as material falls therein. The longitudinal sloping portions of trough 4 are welded or otherwise attached to the right 1A and left 1B longitudinal inner surfaces of the hopper 1 right longitudinal side and left longitudinal side. The single piece of material also has a front side and associated edge that is welded or otherwise attached to an inner surface of the front wall 2; similarly, the single piece of material also has a rear side and associated edge that is welded or otherwise attached to an inner surface of the rear wall 3. An overhang flange 1C or lip is attached to by welding or integrally formed from the top edge running along the longitudinal right and left sides of hopper 1 and the front and rear walls; this overhang flange 1C assists in the rigidity of the hopper 1. Whilst the rear and front walls and sides extend below the trough, they can also stop at the sides and their associated edges of the trough 4 for a more compact structure. The support appurtenances in the design depicted are legs welded to the side walls, but alternatively could be support lugs and could be attached alternatively directly to the trough or even the front and rear walls. The trough is welded to the front and back wall and also to the side inner surfaces. The trough could also be bolted to the walls, and would require additional integral flanges for bolting and gaskets for liquid tight connections.

FIG. 1C presents a front side view of the auger drive assembly 8 in a first embodiment described herein. The auger motor 44 is attached to the inlet of the gear reducer 45. The hollow outlet hole with keyway is depicted in the side view where the gear reducer is able to fit over the auger input shaft. The torque plate 50 is bolted to the gear reducer 45. The torque plate 50 has a torque arm having a slot (opening in triangular structure) that is offset from the outlet hole in the gear reducer that captures the torque pin 51 integrally attached to or formed on support flange 7 and bearing housing 16; this prevents rotation about the auger shaft due to the moment forces created by the motor rotation.

FIG. 1D presents an isometric view of the auger drive assembly in a first embodiment described herein.

FIG. 1E presents an exploded assembly isometric view of the auger drive assembly showing the various components in a first embodiment disclosed herein. Here an opening in the mounting plate 50 is for insertion of shaft 6 on into the gear reducer 45. Screws placed in holes of the mounting plate 50 attach it to the gear reducer using nuts or stud or yoke type.

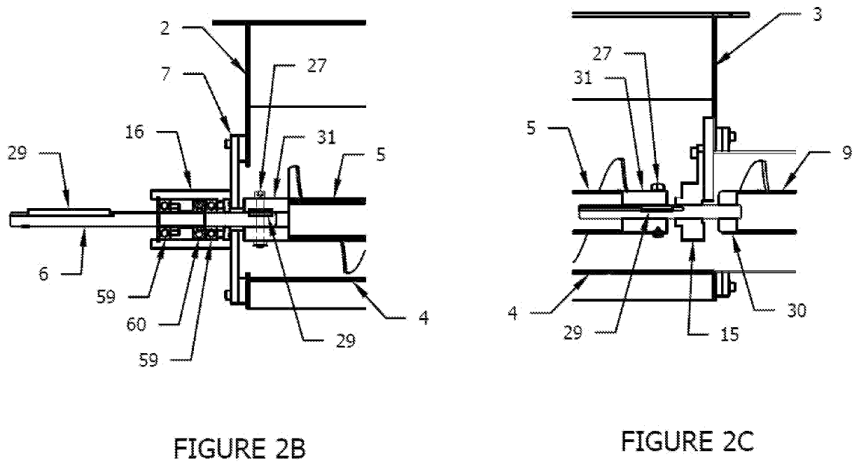

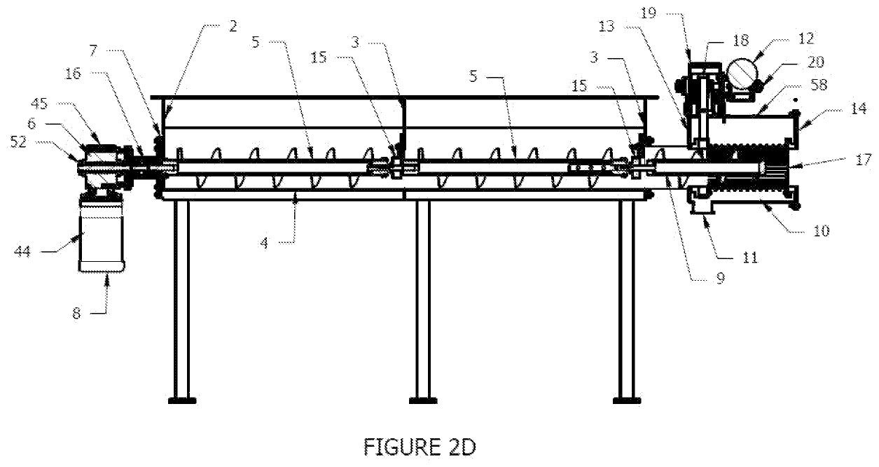

FIG. 2A presents section view of the Dewatering System as shown in FIG. 1A in a first embodiment disclosed herein. In this section view, press internals and function become more clearly defined. Starting from the left side of this view, the auger drive assembly 8 is depicted placed between two shaft collars 52 and attached to an auger drive shaft 6. Auger screw support flange 7 and bearing housing 16 houses a series of auger screw bearings 59, 60 that provide support for the shaft 6 inserted therein as continues on into the hopper 1 interior. These bearings 59, 60 provide support through shaft 6 attached to auger screw 5 so that the auger screw 5 cannot move laterally or longitudinally but is allowed to move rotationally. Radial bearings 59 prevent lateral movement and thrust bearings 60 prevent longitudinal movement. The auger screw support flange 7 is a circular plate having a cylindrical bearing housing 16 integrally associated (or attached by welding or otherwise) therewith. The auger screw support flange 7 has a torque pin 51 integrally associated therewith for association with a torque arm on a mounting plate. The bearing housing 16 has a hole pass through the bearing housing 16 and on through the support flange 7 for entry into a front wall hole of hopper 1; this for insertion of an auger screw drive shaft 6 for connection to auger screw 5. On the right side, supported in the press container 10, a cylindrical screen 17 is depicted. The auger screw tip 9 passes through a portion of the cylindrical screen 17 and is also shown to terminate prior to the end of the cylindrical screen 17. This auger screw tip 9 is attached to the auger screw 5 using hanger bearing 15 where a male portion of the auger screw tip 9 passes through hanger bearing 15 and on to a female attachment of the auger screw 5 as to be discussed in the follow drawings.

The free drain zone starts at the beginning of the cylindrical screen 17 as a drain 11 is shown as a hole at the bottom of the press container 10. The compaction zone starts where the auger screw tip 9 ends to the exit of the press container 10. The cylindrical screen drive assembly 12 is depicted attached to the top of the press container 10. In this view, the power is transmitted to the screen thru a drive belt 18. This could also be accomplished thru a drive linkage serving the same purpose of transmitting power. This view depicts a screen drive support assembly 19 that supports the drive motor and also supports a screen drive shaft 20 that interacts with the drive belt 18 transmitting power for the actuatn of the drive belt. The cylinder screen drive assembly 12 attaches to the screen drive support assembly 19 via gear reducer 45 attached to support 54 with fasteners; this is to be shown more completely in other figures. Two shaft collars 52 are used one on either side of belt drive gear 34 in order to prevent movement of the drive shaft 20 from its position above an opening in bracket 53 and support 54 (shown in other figures); another two shaft collars 52 are also used as described with respect to FIG. 3A. Screen drive support assembly 19 has a moveable support 54 that is capable of movement up and down in association with a bracket 53 attached to the top of press container 10 in order to adjust belt tension. Once proper tension is achieved, fasteners are tightened so that support becomes rigid with the press container 10. FIG. 2A also shows another two shaft collars 52 as well as motor 44 and mechanical gear reducer 45. The mechanical gear reducer 45 is attached to the motor 44 appropriately. First and second shaft collars 52 are attached appropriately to the auger screw drive shaft 6 as described previously that is attached to the mechanical gear reducer 45 and through that connected to motor 44. A machine guard 58 is attached atop the press container 10 acting as a removable attachable lid for providing access to the internal components and for preventing access when attached.

FIG. 2B presents a closeup view of a portion of the left side of the view shown in FIG. 2A in a first embodiment disclosed herein. Here a portion of the left side of the view shown in FIG. 2A shows the auger screw drive assembly removed revealing a shaft key 29 inserted within a hollow or depression in the auger screw drive shaft 6 left portion. The auger screw drive shaft 6 is mounted within the auger screw bearings housing 16; this auger screw bearings housing 16 is integrally formed or attached to the auger screw support flange 7 that itself is mounted by welding or bolts-nuts or similar fasteners to the front wall 2 of the hopper 1 covering an opening in the front wall of the hopper 1. The right portion of the auger screw drive shaft 6 is inserted through the bearings 59, 60 located in the bearing housing 16 and out therefrom into the hopper 1 interior. The right portion of auger screw drive shaft 6 is then inserted within an auger screw connection female adapter 31 integrally formed at a left end of an auger screw 5. A shaft key 29 inserted within a hollow portion of the body of the auger screw drive shaft 6 to mate with a corresponding hollow portion of the interior of the auger screw connection female adapter 31 for locked engagement therewith. This along with an auger screw pin (bolts-nut, screw-cylinder or other fastener system) 27 inserted within corresponding holes in the auger screw connection female adapter 31 and in the right portion of auger screw drive shaft 6 complete the locked engagement between the two parts.

FIG. 2C presents a closeup view of a portion of the right side of the view shown in FIG. 2A in a first embodiment of a Dewatering System disclosed herein. An auger screw 5 is going to be removably attached as shown to an auger screw tip 9 as follows. Here the auger screw 5 ends at its right portion with another auger screw connection female adapter 31 integral therewith. An auger screw connection male adapter 30 (integrally formed or attached to an auger screw tip 9) is inserted through hanger bearing 15 (mounted in a hole/opening in rear wall 3) and locked together with auger screw 5 integral female adapter 31 as shown in FIG. 2B. Here again a shaft key 29 inserted within a hollow portion of the body of the auger screw connection male adapter 30 to mate with a corresponding hollow portion of the interior of the auger screw connection female adapter 31 for locked engagement therewith. This along with an auger screw pin (bolts-nut, screw-cylinder or other fastener system) 27 inserted within corresponding holes in the auger screw connection female adapter 31 and in the left portion of auger screw connection male adapter 30 complete the locked engagement between the two parts.

FIG. 2D presents a side section view of an entire apparatus when modified to have multi-auger screw connection/multi-hopper in a second embodiment disclosed herein. This is a modification of the first embodiment shown in FIG. 1 where a first hopper at left has a second hopper at right attached thereto; this such that rear wall 3 of the first hopper would be the front wall of the second hopper and attached to the bottom and longitudinal sides of both. It should be appreciated that the ‘rear’ legs of the first hopper are removed so that welding/fastening of the bottom and right and left longitudinal sides of the hoppers are supporting the system. More important however, a second auger screw 5 (the additional one(s) in the middle of the drawings) has a different attachment in that there is an integral or attached male adapter 30 at left for the second auger screw 5 that mates with female adapters 31 through a first hanger bearing 15 using the same modality as previously described. Here again a shaft key 29 inserted within a hollow portion of the body of the auger screw connection male adapter 30 to mate with a corresponding hollow portion of the interior of the auger screw connection female adapter 31 for locked engagement therewith. This along with an auger screw pin (bolts-nut, screw-cylinder or other fastener system) 27 inserted within corresponding holes in the auger screw connection female adapter 31 and in the left portion of auger screw connection male adapter 30 complete the locked engagement between the two parts. A machine guard 58 is attached atop the press container 10 acting as a removable attachable lid for providing access to the internal components and for preventing access when attached.

The right side of the middle auger screw(s) would be an integral or attached female adapter that would be attached to the auger tip section 9 as described previously with the auger tip section description with respect to FIG. 2C. FIG. 2D also shows shaft collars 52 as well as motor 44 and mechanical gear reducer 45. The mechanical gear reducer 45 is attached to the motor 44 appropriately. First and second shaft collars 52 are attached appropriately to the auger screw drive shaft 6 that is itself attached through to the mechanical gear reducer 45 and through that connected to motor 44. Four other shaft collars 52 are to be used in association with the screen drive support assembly 19.

FIG. 3A presents a cross section view of the press container with internals (container side walls removed for clarity) of a Dewatering System in a first embodiment disclosed herein. In this section view, the press container 10 internals are further clarified. Support rollers 22 can be mounted in multiple ways; industrially they are known as cam rollers and they come in either stud mount or yoke mount of which either style would work here. One practical application of the embodiments herein described uses the stud mount rollers because it avoids having to allow clearance for a bolt head or nut inside. A series of support rollers 22 protrude from the press container front 13 and rear 14 walls inside the press container 10 that support the cylinder screen 17 assembly. As stated above, these support rollers 22 commonly called cam followers or track rollers may be either yoke mounted or stud mounted. Yoke mounted rollers have a central hole that allow for a standard fastener to bolt the roller to the wall. Stud mounted rollers have an integral stud with a threaded end attached to the roller that would bolt to the wall in a similar fashion. The series of rollers are located such that the roller outside diameters interface with the cylinder screen bearing rings 23 attached to the front and back of the cylinder screen. The rollers allow the cylinder screen to rotate but do not allow the screen to move laterally or longitudinally. The stud mounted cam rollers are shown protruding on the inside walls and the mounting nuts are shown on the exterior of the wall. A spray wand 26 penetrates a side wall that is omitted in this view; it thus could penetrate the front 13 wall and or rear 14 wall (and or right or left side walls of 10) and in either case is typically supported by the wall penetration which is a welded thru wall fitting. In this view, the cylinder screen drive support and mechanism are omitted for clarity.

The screen drive shaft 20 is supported above the press container 10 where starting from the right a first collar 52 is shown attached to the screen drive shaft 20 which would be at the right side of gear reducer 45 (not shown for clarity) of screen drive support assembly 19; a right internal bearing is provided by gear reducer 45. Another two shaft collars 52 are attached to the screen drive shaft 20 one on either side of belt drive gear 34 (all three located within support 53) positioning the drive belt 18 for proper deployment through openings in support 54 and bracket 53 itself attached to the top of press container 10. A fourth shaft collar 52 is attached to the screen drive shaft 20 at the left side beyond drive bearing 28 that is closer to an external portion of support 53 (not shown) and attached thereto. This thereby supports one end of the drive shaft 20 whilst a drive belt 18 interfaces the belt drive gear 34. The drive belt 18 transmits torque to the cylinder screen 17 via a cylinder screen drive ring 24. Brush support bracket 35 is bolted to an opening in the side wall of press container 10 which is omitted in this view which is why it appears to be floating. One or more stationary brushes 21 attach to the brush support bracket 35 that attaches to the press container housing. A circular flanged tubular structure 33 that connects the press container main body to the hopper 1 is also shown.

FIG. 3B presents a front view of the press container of a Dewatering System in a first embodiment disclosed herein. In this view, the cylinder screen drive support and mechanism are omitted for clarity. The screen drive shaft 20 is supported above the press container. Drive bearing 28 is shown (connected to a side of support 53—not shown) that supports one end of the drive shaft whilst a drive belt 18 interfaces a belt drive gear 34. The belt transmits torque to the cylinder screen 17 via a cylinder screen drive ring 24. A stationary spray header 26 (or spray wand) is supported by the press container 10 and is located above the cylinder screen 17 and is capable of spraying the cylinder screen 17 outside diameter. The stationary spray header 26 (or wand) is connected to a liquid supply (water or other cleaning fluid) through piping that passes through an opening in the side of the press container 10. One or more stationary removable rigid brush(es) 21 is supported by the press container 10 where the brush(es) 21 is in contact with the screen outside 17 diameter. The stationary brush(es) 21 attaches to a brush support bracket 35 using clip fasteners (welded to each brush) to mounting protrusions integrally formed, associated or welded to the brush support bracket 35; the brush support bracket 35 itself attaches (bolt nut or other fastener) to a portion of the press container 10 housing U shaped piece of material. The brush is able to be removed from the outside of the housing so the brushes can be replaced with minimal disassembly. Necessary gaskets to prevent leakage are included.

FIG. 3C presents an isometric view of the press container 10 with the cylindrical screen drive assembly 12 (or cylinder screen drive assembly) installed. The rear press container wall 14 is visible in the rear of the press container 10 with a spring loaded door 36 as an exit restriction mounted to the rear wall and a front wall 13 of the press container 10 is attached to the front of the press container 10. A cylinder screen drive support assembly 19 has a support 54 movably attached to a bracket 53. A lower portion of the bracket 53 is rigidly bolted (welded or otherwise attached) to a top portion of the press container 10. A side portion of the support 54 which movably mounts the cylinder screen drive assembly 12 to the top of the press container is movably connected to a top portion of the bracket 53 by a hinge 55. The hinge 55 is offset from the axis of motor shaft 20 and allows the support 54 to swing up and down about the hinge 55 and bracket 53. On the opposite side of the hinge 55 near a left longitudinal side of the press container 10 are two tension screws 56. The tension screws 56 are threaded thru threaded holes in a lip of support 54. By threading the screws 56 thru threaded holes in the support 54, the screws come into contact with a part of bracket 53. Threading the screws 56 further into the holes will cause the support 54 to move upwards and thus provides the ability to tighten and loosen the drive belt for installation and removal and vice versa for moving the screws 56 out of the holes as this causes support 54 to move downwards; thus, the motion of screw(s) 56 causes the screen drive assembly 12 to move up or down using hinge 55. An upper portion of the support 54 contains the rotating shaft and drive gear 34; this upper portion has (welded and/or bolted) a machine guard 57 at top to prevent direct access to the moving parts. The top of the press container 10 also has a machine guard 58 (welded and/or bolted to top of press container 10) located adjacent to the screen drive support assembly 19 (support 54, bracket 53, hinge and so forth) that acts as a removable lid that also prevents direct access to moving parts when the lid is attached to the top of press container 10. The machine guard 58 (lid cover) is a rectangle and covers the portion of the press container that isn't covered by the screen drive support assembly 19 bracket 53. A circular flanged tubular structure 33 that connects the front of the press container 10 main body to the hopper 1 is also shown. The cylinder screen drive assembly 12 has a motor 44 with gear reducer 45 movably integrated with the screen drive shaft 20 that is held in place with four shaft collars that properly position the components for rotation about bearing 28 on one side and an internal bearing of gear reducer 45 on the other side; the screen drive shaft 20 and belt drive gear 34 is mounted within slots or openings in the support 54 and covered by machine guard 57 at top.

FIG. 3D presents an isometric exploded view of the press container 10 with press container 10 box and spray wand (header) pulled away from the internal components in a first embodiment disclosed herein.

FIG. 3E presents an isometric exploded view of press internals in a first embodiment disclosed herein. The cylindrical screen 17 is moved down in the figure whilst the rear wall 14 has been pulled away (to the upper right in the figure) from the press container 10 U shaped box revealing the mounting bolts that attach it thereto; the front 13 and rear walls 14 are welded or otherwise attached to a U shaped piece of material at front and rear respectively, thereby forming the aforementioned U shaped box. The top edge of the U shaped box has a rectangular perimeter which has been bent down (on front and rear walls and U shaped piece of material) forming a lip or flange about the perimeter thereof. Next, removable spring door assembly 36 is moved further away (to the upper right in the figure) from the rear wall 14; the removable spring door assembly 36 is shown having a door frame, comprising a door with hinge located on the door and springs attached to door lugs at either right or left side of the door. The other end of each spring is for attachment using mounting plates on the outside of press container 10. The top of the press container 10 also has a machine guard 58 (welded and/or bolted to top of press container 10) located adjacent to the screen drive support assembly 19; this acts as a removable lid that also prevents direct access to moving parts when the lid is attached to the top of press container 10. Various rollers 22 are shown that are attached to the internal front and rear walls 13, 14 and thereby facilitating the rotation of the cylinder screen 17 thereupon. A lower portion of the bracket 53 is rigidly bolted (welded or otherwise attached) to a top portion of the press container 10. A side portion of the support 54 which indirectly movably mounts the cylinder screen drive assembly 12 to the top of the press container 10 is movably connected (directly) to a top portion of the bracket 53 by a hinge 55. The hinge 55 is offset from the axis of motor shaft 20 and allows the support 54 to swing up and down about the hinge 55. On the opposite side of the hinge 55 near a left longitudinal side of the press container 10 are two tension screws 56 used to facilitate the aforementioned motion up and down of support 54 and cylinder screen drive assembly 12.

FIG. 3F presents an isometric view of the screen motor support 54 and bracket 53 with the drive assembly and support bearing mounted thereon in a first embodiment disclosed herein. Here the press container 10, the cylinder screen 17, front wall 13, rear wall 14 and spring door assembly 36 are omitted. A screen drive support assembly has a bracket 53 movably attached to a support 54. A side portion of the support 54 is movably connected to a top portion of the bracket 53 by a hinge 55. The hinge 55 is offset from the axis of motor shaft 20 and allows the support 54 to swing up and down about the hinge 55. On the opposite side of the hinge 55 are two tension screws 56. The tension screws 56 are threaded thru threaded holes in a lip of the support 54. By threading the screws thru threaded holes in the support 54, the screws come into contact with a part of bracket 53. Threading the screws further into the holes will cause the support 54 to move upwards and threaded them outwards cause the support 54 to move downwards; thus, this provides the ability to tighten and loosen the drive belt for installation and removal (and vice versa screws outwards moves support 54 down). An upper portion of the support 54 contains the rotating shaft and belt drive gear 34; this upper portion has (welded and/or bolted) a machine guard 57 at top to prevent direct access to the moving parts. The cylinder screen drive assembly 12 has a motor 44 with gear reducer 45 movably integrated with the screen drive shaft 20 that is held in place with bearing 28 and an internal bearing of gear reducer 45 along with four shaft collars as previously described. The screen drive shaft 20 is located within slot(s) or opening(s) in the support 54 and covered by machine guard 57 at top. A drive belt 18 is associated with the drive gear and rotating shaft thereby driving the cylinder screen. The rotating belt 18 is threaded within an opening or hole in the in the lower side of the support 54 and through another opening in bracket 53 thereby permitting rotation of the cylinder screen 17 positioned lower in the press container 10.

FIG. 3G presents an exploded assembly view of FIG. 3F in a first embodiment disclosed herein. In this view it is clear how the drive shaft 20 is supported on one side by the drive bearing 28 and supported rotationally on the other side by an internal bearing of the gear reducer 45 which is itself bolted directly to the support 54 at a side thereof. A drive bearing 28 is screw attached to the front side of support 54 about a front opening therein and is disposed centrally about the front opening, slot or hole in the front of support 54. There is a first shaft collar 52 that is locked on drive shaft 20 outside of support 54 and prior to drive bearing 28; that is, this first shaft collar 52 is located external to the bearing 28—support 54 interface; and as it is the furthest object on the drive shaft 20 near a front end thereof it prevents release of the drive shaft 20 through the bearing 28 and out through the gear reducer 45 internal bearing. A second shaft collar 52 is attached on the drive shaft 20 on an opposite end of the front end that the first shaft collar 52 is on. As the drive shaft 20 emerges from a gear reducer 45 also mounted on the drive shaft 20, this second shaft collar 52 locks the drive shaft 20 in place so that it won't detach and slide away from the gear reducer internal bearing and out through drive bearing 28. Also, the gear reducer 45 has a mounting plate that attaches it with fasteners (bolt—nut or other type) to a rear side of the support 54 and is associated with motor 44. It should be noted that this mounting plate does not have a torque arm for attaching to a torque pin.

The gear reducer 45 also has an internal bearing to facilitate rotation of the drive shaft 20. The front side of gear reducer 45 is attached with appropriate fasteners to the rear side of the support 54 about the rear opening, slot or hole in the rear side of support 54 from which the drive shaft emerges. A second front opening, slot or hole in the front side of support 54 supports the drive shaft 20 as it emerges at the front of support 54. As a result, this arrangement keeps the drive shaft 20 in place and prevents it from having lateral movement. Screen guard 57 is an upside down L shaped device that attaches to the top portion of the support 54; it is attached by a narrow portion at left sliding into a slot or opening in a top box of the support 54 whilst a small downwards portion is attached by fasteners to the right of the box of the support 54.

FIG. 3H presents an isometric exploded view of the screen motor support 54 and bracket 53 with the screen drive assembly 12 and support bearing 28 omitted in a first embodiment disclosed herein. In this view the drive shaft details are shown including location and mounting detail of the belt drive gear 34 that interacts with the drive belt 18. A shaft key 29 is shown that interacts with the keyed gear reducer 45 for facilitating rotational motion thereby. The drive belt gear 34 is rigidly attached to the drive shaft 20 using shaft collars 52 on either side attached to the shaft; this thereby prevents longitudinal movement up or down the shaft and a key 29 between the gear and shaft is implied (not shown) to lock rotation of the drive belt gear 34 to the drive shaft 20. This could also be achieved by welding the gear to the shaft or by use of other known methods of securing gears to shafts. The drive shaft 20 is positioned within the support 54 using front and rear opening or holes therein and rests on curved portions thereof; as a result, the drive belt gear 34 is positioned within the support 54 and held in place. The drive belt 18 interacts with belt drive gear 34 as it threads through an opening or hole in the lower side of the bracket 53 and on and around belt drive gear 34 for rotation therewith. A lip is formed at left in support 54 in the figure as a small L shaped structure shown integrally formed or attached to the rest of the structure; a small portion of the lip structure has holes for insertion of the screws 56. A second lip integrally formed or attached (to the rest of the support 54) at right on support 54 is used to attach a dual knuckle structure by welding. The support 54 is formed as four sided box having an opening at top and at bottom with and with slots or openings at front and rear sides for drive shaft 20.

It should be apparent that the hinge 55 is formed from two knuckles attached to a right portion of the support 54 with two other knuckles attached to a right portion of the bracket 53; this thereby forms two pairs of knuckles where each pair has one knuckle from the bracket 53 and one knuckle from the support 54. The knuckles located on the bracket 53 are welded or otherwise attached at a right top flat portion that is attached (welded) to front and rear vertical connections that are themselves attached (welded) to the lower portion of the bracket 53. The bracket 53 also has two raised integral stops extending upwards from a lower portion of the bracket; these are disposed at left and block downwards motion of the support 54 beyond acceptable limits. Two bolt—nuts attach each pair through holes in the knuckles; alternatively, two flat headed pins are threaded one per knuckle pair and locked with a cotter pin in a hole in the flat headed pins; or a single flat headed pin is threaded through the knuckle holes and locked with a cotter pin in a hole in the flat headed pin. Finally, bracket 53 has a large front wall and a large rear wall as well as a small right wall and a small left wall forming a protection zone (attached/welded to the inner surface of the lower portion of the bracket 53); this protection zone about an opening or hole in the lower portion of the bracket 53 that passes the belt 18 for protecting the belt thereby from interaction of overflow or other materials.

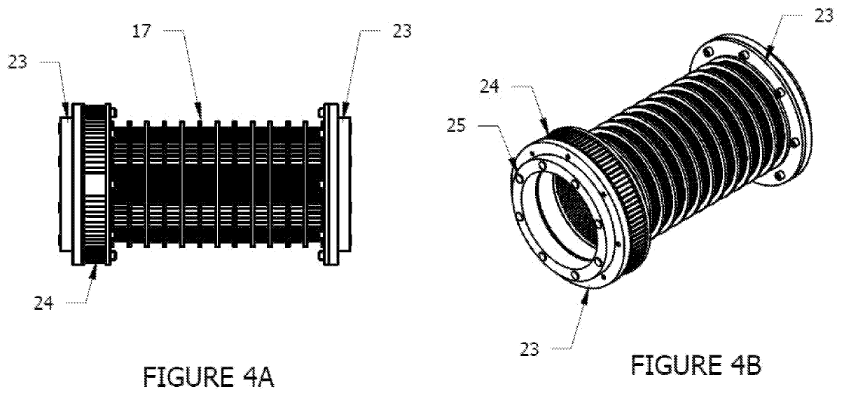

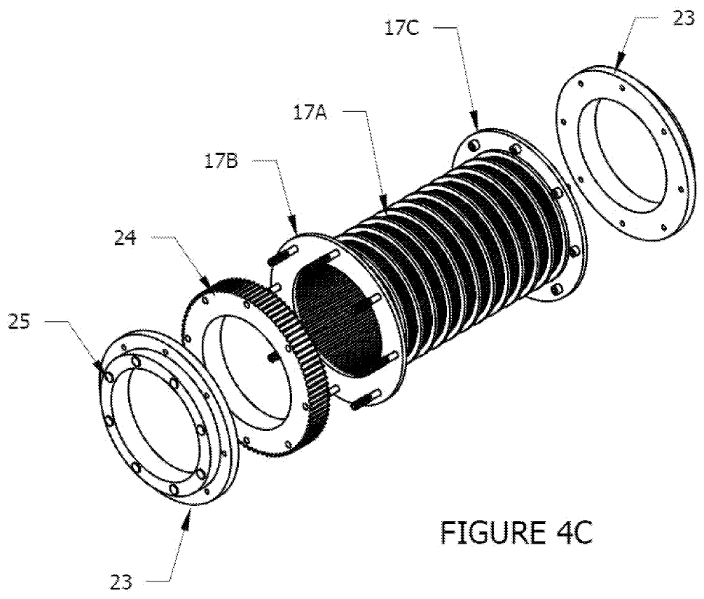

FIG. 4A presents a side view of a cylinder screen 17 assembly of a Dewatering System in a first embodiment disclosed herein. In this side view of the cylinder screen 17 assembly the main components thereof are detailed. Cylinder screen bearing rings 23 are shown attached to the front and back of the cylinder screen 17. One of the bearing rings 23 is attached to the inwardly directed surface (towards the hopper 1) of the cylinder screen drive ring 24 and this ring 23 has a smooth round surface for rollers within the press container 10 to smoothly guide and support the cylinder screen 17 rotationally; cylinder screen slide pads 25 are also shown attached to the inwardly directed surface (left) of the most external ring of the cylinder screen bearing rings 23 and the right outwardly directed surface (right-away from hopper 1). The cylinder screen drive ring 24 is shown in this view to have geared teeth on the outside diameter. This is applicable for drive belts with teeth 18 but could also be driven on a pulley without teeth.

FIG. 4B presents an isometric view of cylinder screen 17 assembly of a Dewatering System in a first embodiment disclosed herein. In this isometric view of the cylinder screen 17 assembly, the main components thereof are shown in a different perspective. Cylinder screen 17 support bearing ring slide pads 25 are shown on the inwardly directed surface of the most external annulus of the cylinder screen bearing ring 23 and the right most external annulus of the cylinder screen bearing ring 23. These support bearing ring slide pads 25 are present on the front (towards hopper 1-left) and the back (right) bearing rings 23. As the cylinder screen 17 assembly is contained between the press container 10 front and rear walls, the bearing ring slide pads 25 are attached along the circumferential face that points longitudinally to either front or rear wall of the press container 10; this helps prevent metal to metal contact between the front and rear wall of the press container 10 and the cylinder screen 17 assembly.

FIG. 4C presents an isometric exploded components assembly view of a cylinder screen assembly of a Dewatering System in a first embodiment disclosed herein. A cylinder screen 17 assembly has two integrally formed bearing rings 23 one at either end thereof; each of these two integrally formed bearing rings 23 has a first annulus which is integrally formed (one chuck of steel that is precision machined into that shape, welded or formed as a unit through molding, stamping, bending, pressing, etc.) with a larger second annulus both of which have the same internal diameter. However, the first annulus has a smaller external diameter than the second annulus so that the external (farthest radially) circumferential surface of the first annulus serves as a bearing for the rollers previously described; the first annulus also hosts the bearing ring slide pads 25 on the axially (and or longitudinally) directed surface thereof. It should be understood the second annulus (the larger one) has a circular group of holes having a circular group of threaded pins inserted one per hole axially (and or longitudinally).

A first set of threaded pins welded, placed within corresponding holes of 17C, or otherwise attached to a third annulus 17C welded to the cylinder screen body 17A rear end extends outwards (away from hopper 1—not shown) towards corresponding holes in the second annulus of cylinder screen bearing ring 23 at right; a second set of threaded pins welded, placed within corresponding holes of 17B or otherwise attached to a fourth annulus 17B welded to the cylinder screen body 17A front end extends inwards (towards hopper 1—not shown) to corresponding holes in a second cylinder screen bearing ring 23 at left. It should be apparent from the figure that the cylinder screen 17 assembly is formed from a screen body 17A formed as a tight mesh or screen having two annuli 17B, 17C (one at either end welded thereto); thus, an inlet flange 17B is welded to the screen body 17A front at left in the figure and an outlet flange 17C is welded to the screen body 17A rear at right in the figure.

However, the left connection which is directed to hopper 1 (not shown) also passes these pins through a fifth annulus formed as the cylinder screen drive ring 24 which has corresponding holes therein for this purpose. In this figure, each cylinder screen bearing ring 23 second annulus has threaded holes so that nuts aren't required, in other words the threaded pins attach to the threaded holes in the respective bearing ring 23; however; with adequate clearance, nuts could be used instead of threaded holes. Thus, alternatively, these are locked with a nut on each threaded pins (or bolts) as each exits out its respective hole in either cylinder screen bearing ring 23. This cylinder screen drive ring 24 has a sequence of teeth integrally formed thereon for driving the assembly using a corresponding toothed belt. The primary solution here is that each cylinder screen bearing ring 23 has threaded holes attached to a single one of a fourth annulus 17B or a third annulus 17C using corresponding threaded pins placed within holes in a single one of fourth annulus 17B or third annulus 17C so that there are no nuts to interfere with the cam rollers that ride on the outer ring surface/race.

FIG. 5A presents a side view of an auger screw assembly of a Dewatering System in a first embodiment disclosed herein. Here the drive shaft 6 is shown being rotationally attached to the bearing auger screw support flange 7 and bearing housing 16; this by fixed attachment to the auger screw section 5 and auger tip 9 section. In this side view of the auger screw assembly, all sections of the assembly are shown assembled. On the left, the auger screw drive shaft 6 is shown mounted within the auger screw support flange 7 and bearing housing 16. This is the anchor for the assembly that would be attached to the front wall of the hopper 1 by appropriate welding or fasteners about a hole in the front wall of the hopper 1. The auger screw support flange 7 has a bearing housing 16 integrally formed or attached thereto; this bearing housing 16 contains a set of bearings that facilitates the rotational motion of the auger screw drive shaft 5. Radial bearings 59 prevent lateral movement and thrust bearings 60 prevent longitudinal movement. Longitudinal movement is prevented by a series of removable retaining rings attached to both auger shaft 6 and bearing housing 16. Auger screw section 5 is supplied with keyed female adapters 31 on both left and right side. On the left side, the auger screw drive shaft 6 is inserted into the keyed female adapter 31 and pinned in place by ether a pin or bolt 27 that goes thru holes in both auger screw drive shaft 6 and the female adapter 31 that prevents longitudinal movement between the two pieces. A shaft key 29 is provided between the two parts so that torque can be transmitted between the two parts. On the right side, a similar connection is made; however, the male adapter 30 is integrally attached to or formed on the auger screw tip 9. This piece has multiple connection holes for different positions that will be described in other figures. Coil brushes 32 are attached to the auger flights located in the free drain zone.

FIG. 5B presents an exploded side view of an auger screw assembly of a Dewatering System in a first embodiment disclosed herein. In this exploded view of auger screw assembly, the male and female locations and orientations are clearly identified. It should be noted that other configurations are possible, however the orientation shown here is the preferred. When disassembling the device, positioning the female adapters 31 on top of the auger screw section 5 that is located in the collection hopper 1. This allows for the auger screw drive shaft 6 (which was inserted within female adapter 31 through bearing housing 16 and support flange 7) and support flange 7 to be removed and also auger screw tip 9 to be removed while the auger screw section 5 remains at the bottom of the hopper 1. These two female adapters 31 are machined parts that are attached to the auger screw 5 such that they are welded on each end thereof; alternatively the two female adapters 31 are integrally formed from auger screw 5. In contradistinction, the auger screw tip 9 has a male adapter 30 welded to it, or formed integral therewith. If the auger screw 5 had male components that protruded outwards from one or both ends thereof as opposed to female ends, the overall length would be longer than the width of the hopper and the screw would have to be removed thru either the front or rear wall because it would be too long to be removed thru the open top. Alternatively, any of the axial type connections of auger screw 5 and auger tip 9 are male and female and the locations of the male and female pieces are interchangeable in any combination or permutation thereof.

Auger screw threaded pin/threaded bolts/nuts 27 are shown at left and at right in the drawings for corresponding insertion: A) in the auger screw drive shaft 6 right portion hole(s) and hole(s) in the auger screw connection female adapter 31 at the left end of the auger screw 5; B) as well as into hole(s) in the auger screw connection female adapter 31 at the right end of the auger screw 5 and into corresponding hole(s) of the auger screw connection male adapter 30 (integrally formed or attached to the left end of the auger screw tip 9). Also shown is a shaft key 29 inserted within an auger screw male adapter 30 placed within a hollow therein for corresponding engagement with a similar hollow on the inside surface of the auger screw connection female adapter 31 of the right end of the auger screw section 5.

Depending on machine clearance, it is generally desirable to be able to remove the auger screw 5 thru the hopper 1 open top instead of having to remove the screw laterally. Coil brushes 32 are attached to the auger flights located in the free drain zone. Brushes are either welded or clamped to the edges of the flights so that they can constantly clear solids from blocking the screen and allow for the free water to continue to drain. Brushes wear over time and routinely have to be replaced during routine maintenance.

FIG. 5C presents a side view of an auger screw tip of a Dewatering System in a first embodiment disclosed herein. In this detail figure of the auger screw tip 9, the auger screw connection male adapter 30 (integrally formed or attached to the auger screw tip 9) can be seen in its profile position that shows the multiple mounting holes that can be selected to change the overall auger length and thereby controls the length of the compaction zone; as a result, the overall auger length is variable as a result of the choice of connection hole. The protruding auger screw male adapter 30 is rigidly fixed to the auger screw tip 9 either by welding or by integral formation therewith. On the left side of the shaft above the mounting holes, a keyway is depicted. A shaft key is provided between the male and female connectors to transmit torque through the connections. It should be noted that mounting bolts 27 are designed to prevent longitudinal movement and the shaft keys 29 are designed to transmit torque. Shaft keys have tighter tolerance fits therefore the bolts 27 should not experience high loads from torque because they have a looser fit than keyed connections.

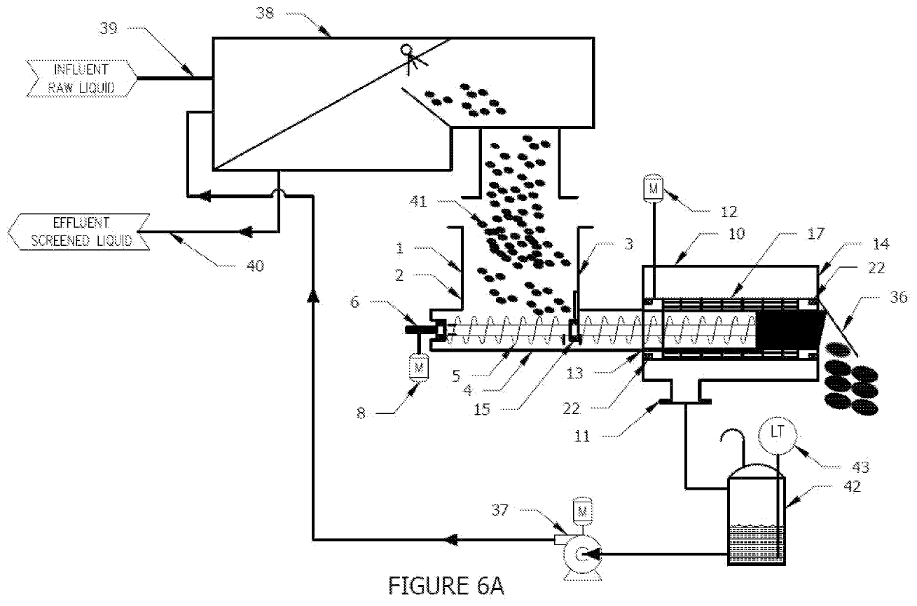

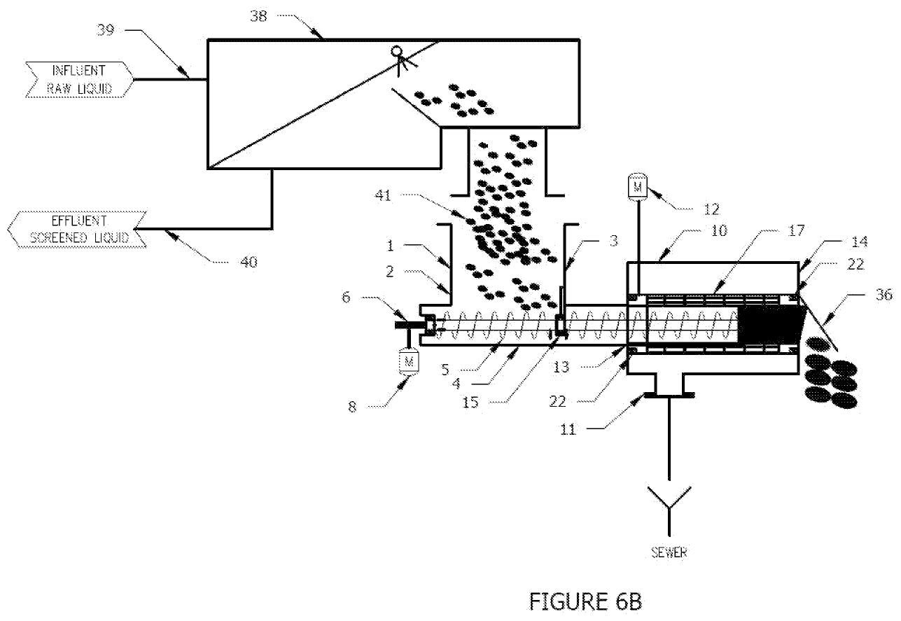

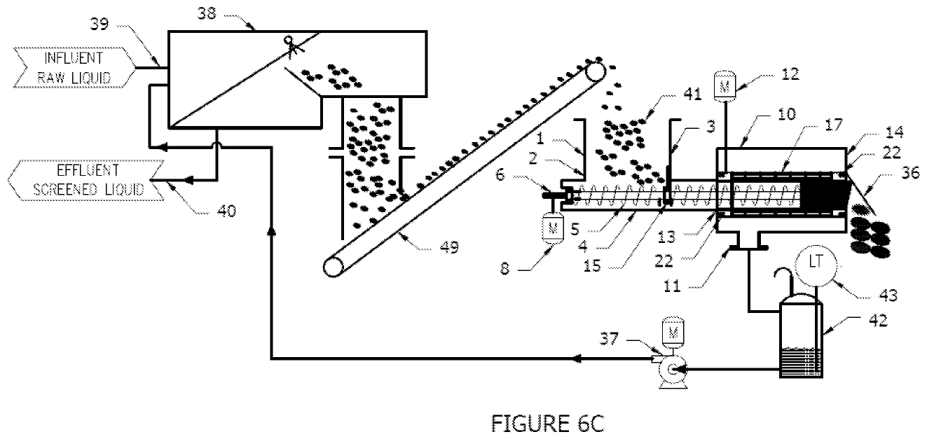

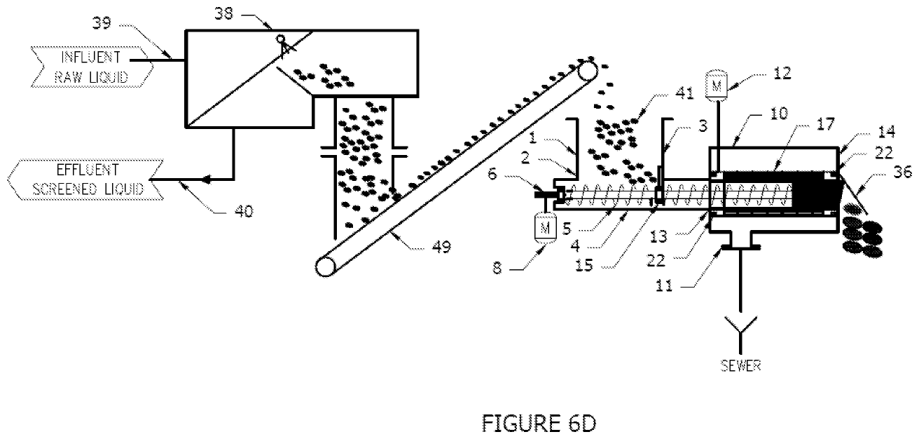

FIG. 6A presents a schematic of integration of press with an Automated Liquid Solid Separator of a Dewatering System in a third embodiment disclosed herein. This figure shows integration of dewatering press with an Automated Liquid Solid Separator screening equipment 38. A press filtrate collection sump 42 is provided receiving liquids from a connection to the press container drain 11 of the press container 10 thereby collecting press filtrate that gravity flows from the press container 10. When the sump level rises above a determined set point, level transmitter 43 (float switches or any other measuring device capable of detecting liquid level in the press filtrate collection sump 42) sends a wired or wireless electromagnetic signal to a PLC controller (not shown) that activates the sump pump 37 (connected to sump 42) which can either be located inside or outside the sump 42. Once the liquid level in the sump falls below a set point, the pump is turned off by the level transmitter transmitting appropriate data to the PLC controller that in turn signals the sump pump 37 to shut off.

As the sump 42 is connected to sump pump 37, this signal to the sump pump 37 causes the discharge of the sump 42 thru a pipe, thru the pump and through a hose or conduit to an automated liquid solid separator screening device 38 using a mesh filter media of 300 microns (0.012 in.) openings or smaller. The sump pump 37 discharge enters the automated liquid solid separator 38 prior to the screening process, near the automated liquid solid separator influent raw liquid connection 39. The press filtrate is re-screened and exits the automated liquid solid separator into the automated liquid solid separator effluent 40. It should be apparent that the automated liquid solid separator device 38 is held in place by a support structure above the hopper 1 such as a stand or bracket(s) (or other device disposition permitting this) that has an opening at bottom permitting the effluent and wet solids 41 to fall into the hooper 1. The auger screw drive assembly 8 attached to the auger screw drive shaft actuates rotation of the auger screw section 5 using its auger screw support shaft and bearing assembly 7 at left and hanger bearing 15 mounted at the rear wall 3 of the hopper 1.

Effluent and wet solids 41 falling from the opening in the automated liquid solid separator device 38 fall into the hopper 1 and are conveyed using the auger screw 5 (and any attached auger screw tips 9) from trough 4 into the press container 10 and through the cylinder screen 17 mounted therein on cylinder screen roller bearings 22 mounted near the press container front wall 13 and the press container rear wall 14. The cylinder screen is driven by a cylinder screen drive assembly 12 that attaches by chain or belt to the cylinder screen drive ring 24. Finally, materials fall out of an opening in the press container rear wall 14 that can optionally have a restriction such as a hinged door 36 or similar mechanism attached thereto; this option permits the modulation of the thickness of the resulting solid matter exiting the opening of the press container rear wall.

FIG. 6B presents a schematic of integration of press with an Automated Liquid Solid Separator without recirculation and having drainage to a sewer of a Dewatering System in a fourth embodiment disclosed herein. Here the figure represents the same system as that of FIG. 6A except that there is no re-screening of materials to the hopper 1 as there is no sump 42, level transmitter 43 in the sump 43, recirculation pump 37 nor conduits/pipes/hoses there between. Rather the press container 10 drain 11 has a connection/conduit or opening into a sewer pipe or open waterway or sewer passage or sanitary sewer.

FIG. 6C presents a schematic of a conveyor system integration of press with an Automated Liquid Solid Separator with recirculation through use of a sump of a Dewatering System in a fifth embodiment disclosed herein. Here the system is similar to FIG. 6A, however, a few more changes have been made. First the opening at the bottom of an automated liquid solid separator 38 is situated directly above a (rotational or otherwise) conveyor system 49 designed to move wet solid waste mounted upon a support structure (for the conveyor system 49 not shown) and is driven by an electric motor (not shown). This conveyor system 49 is a belt, screw, drag chain or other type of conveyor designed appropriately for the movement of wet solid waste. Effluent and wet solids falling from the opening in the automated liquid solid separator 38 fall onto the conveyor system 49 and are driven up above the hopper 1 such that the end of the conveyor system 49 is positioned so that effluent and wet solids 41 fall into the hopper 1. Recirculation happens as in FIG. 6A except now some are returned through the Conveyor 49.

FIG. 6D presents a schematic of a conveyor system integration of press with an Automated Liquid Solid Separator without recirculation and having drainage to a sewer in a sixth embodiment disclosed herein. Here the system is similar to the system of FIG. 6B as there is no recirculation and the exit at 11 is to a sewer; and it is similar to the system of FIG. 6C in that there is a conveyor system 49 located below the opening in the automated liquid solid separator.

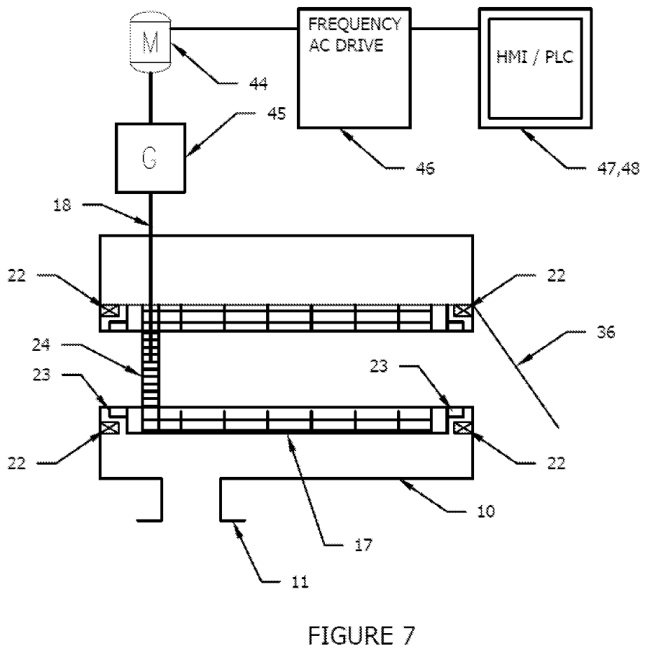

FIG. 7 presents a view of an electronic computer system useable in the first to sixth embodiments disclosed herein. A human machine interface HMI 47 is electronically associated with a programmable electronic controller PLC 48. These are associated by appropriate wired or wireless communication with a variable frequency AC drive (VFD) 46 so as to control an electric motor 44. The electric motor 44 is connected to a cylinder screen drive belt 18 in physical association through appropriate opening(s) in the press container 10 with cylinder screen drive ring 24 of cylindrical screen 17. A mechanical gear reducer 45 is placed appropriately in association with the electric motor 44 to reduce speed and increase torque as necessary or to act as a brake when the motor is not active.

Several cylinder screen support drive rollers (rollers 22 for short) are mounted on the interior of press container front wall 13 and the press container rear wall 14 for support of one or the other of the cylinder screen bearing rings 23 first annulus thereby facilitating rotational motion of the cylindrical screen 17 as acted upon by the cylinder screen drive belt being 18 driven by electric motor 44. Finally, an optional hinged door restriction 36 is shown attached to the top of an opening at right in the figure and an integral press container drain 11 is shown at bottom.

Item 45 is a gear reducer used in coordination with electric motor 44 to reduce speed and increase torque as necessary or to act as a brake when the motor is not active. Input shaft is the motor shaft, output shaft is slower with more torque that drives the screen. Gear reducers will always have an input and an output. Most typical electric motors have a male output shaft however some have female outputs, but this is rare. Gear reducers however come in many configurations. Input can be female or male and output can also be male or female. Clearly, the motor (44) is coupled to the gear reducer (45) input and the belt drive shaft (20) is coupled to the gear reducer (45) output. This results in the belt drive shaft (20) operating at a slower speed with higher torque than the motor (44). It should be apparent that rollers 22 are attached to front 13 and real walls 14 of press container 10. Rollers 22 use stud mounted cam rollers that have nuts on the outside of the walls. The exemplary embodiments described herein use AC drive designed by Allen Bradley Model 25B-D2P3N104

Operation: The electric motor 44 has (3) states available in the HMI 47. The three states are OFF, HAND, & AUTO. Here the OFF state exists to disable the electric motor 44. The HAND state allows the motor to be turned on and the user is asked by an HMI software displayed query (or subroutine of a control problem therein stored) to provide a desired speed in a range of 20-100%; this HAND state also accelerates the electric motor 44 to the desired speed and ensures that the electric motor 44 remains at a constant speed until the operator changes the electric motor 44 state or the equipment system is turned off by the user. Finally, AUTO function is a state whereby the PLC will run an automated program providing a unique set of commands dedicated to the particularly type of treatment desired. In the AUTO mode, there will be several set points that may be entered by the user or may be embedded in the PLC program which may not be accessed by the user.

AUTO mode: In this state, the electric motor 44 is either continuously turning at a slow speed at a predetermined set point, or it will turn intermittently at a slow speed at predetermined set points for predetermined durations on predetermined timed intervals. In the AUTO mode, the entire press system runs intermittently based on demand. When the system turns off, the screen rotation electric motor 44 also turn off. When the system automatically turns on, the screen rotation electric motor 44 also turns on. The system turns automatically on and off when material to be pressed is detected. In the case when the press is integral with a conveyor, the system detects water (liquids) which activates the system. In the case when the press is integral with an Automated Liquid Solid Separator, the overall system may be activated by detecting that liquids are present to be screened. This can occur by several methods. One being the detection of liquids in the automated liquid solid separator by ether a level instrument or by a flow meter. The system could also be turned on by sensing that a pump that feeds the entire system has been activated. During cleaning operations, the screen rotation speed may vary from normal operational speed usually to a faster speed to reduce clean process time duration to minimize water usage for cleaning processes.

An automated anti press clogging feature may be activated when the auger screw motor load increases beyond the operational limits of the motor. High motor loads are a typical when material is jamming the press. It is common to be able to clear jammed material by briefly running the auger screw in reverse. When an anti-jamming feature is active and or when the drive senses a high load beyond the specified operating range of the motor, the auger screw drive and screen rotation motor will stop briefly, then both screw and screen motors will slowly engage moving in the reverse direction for a set duration, usually 5 to 15 seconds. Then the screen and auger motors will stop briefly and slowly start in the forward direction. The auger and screen will slowly accelerate until they reach their operational speed.

If a high load is detected again, the same reversing sequence will be activated again. This will repeat itself for several iterations, usually 3 to 5 iterations. If the high auger motor load can not be cleared after the predetermined maximum iterations, then the system will fault and shut down with a fault alarm activated. At this point, the operator will need to investigate the fault condition. If the high load is cleared, the system will resume normal operation. A warning alarm may be sent, but will not shut the system down and will clear after a set time of operation, usually 1 hour.

Set points in the Dewatering System are optionally based upon time, quantity of output cake, quantity of input/output sludge/slurry, Input or Output volume, liquid capacity Input or Output processed, daytime, nighttime, mass or similar types of quantities or combinations of the foregoing. Some Examples of user set points are motor speed, whether the motor will spin continuously or intermittently and if intermittently for how long (durations in time) and how often (intervals in time). Referring to the dewatered solids here as cake, the characteristics of the cake will vary depending on the ingredients and the different properties that dictate what works best. For example, sometimes rotating or turning the cage too rapidly could result in loosening the plug in the compaction zone resulting in ‘a wash out’ where the plug simply gets soft and comes loose. In this case, you may want to slow down the turning and make it only intermittently. Some of the softer cake materials, if they are pressed hard will squeeze thru the screen openings and won't go out the exit restriction. In these cases, you have to adjust the restriction so that is it very small and then you need to keep the rotation on all the time very slow to keep the material moving with just enough back pressure so that material isn't lost thru the screen slots. Figuring out what works best is usually a trial by error method of just trying different things. When adjusting to the materials being processed in a pilot application and figuring out what works, the set point program limits the end user set points variables; this so that the end user can not foul the function by entering bogus set points outside the known range of what has already been proven to work.

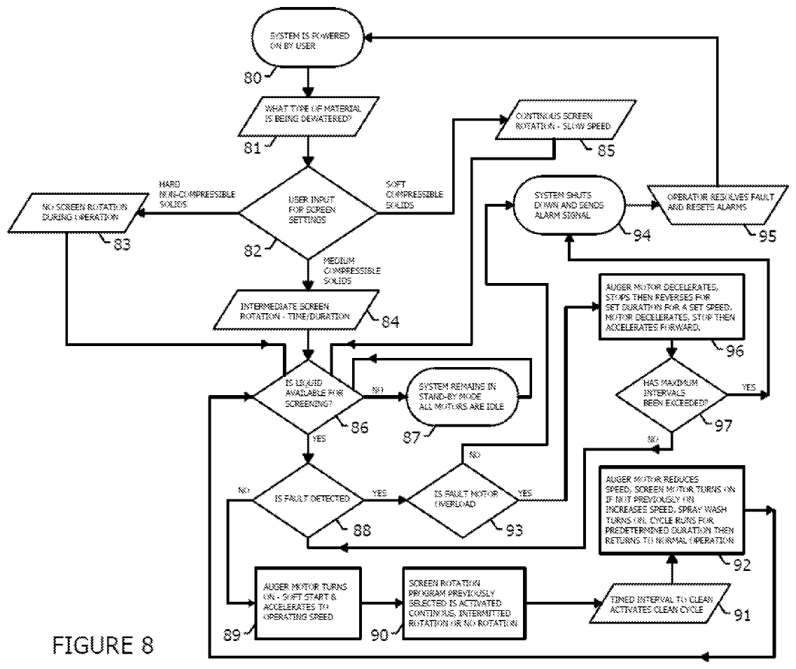

FIG. 8 presents a flowchart of the operational control of a Dewatering System in any of the embodiments disclosed herein. At step 80 the user powers on the Dewatering System and a prompt is presented 81 at the HMI asking the user what type of material is being dewatered. The user enters 82 an input choice selecting one of three types of solid materials: a) Hard Non-Compressible Solids; b) Medium Compressible Solids; c) Soft Compressible Solids. When a user selects Hard Non-Compressible Solids the PLC commands No Screen Rotation During operation in step 83 and proceeds to step 86. When a user selects Medium Compressible Solids the PLC commands 84 Intermediate Screen Rotation for a selected or predetermined time in the HMI and proceeds to step 86. When a user selects Soft Compressible Solids the PLC commands a continuous screen rotation at a slow speed and proceeds to step 86.

At step 86 the PLC determines if there is any liquid available for screening and if there is not liquid available the Dewatering System enters into a stand by mode 87 where all motors are idle. However, if there is liquid available then the PLC determines 88 if there is a fault detected. If there is no fault detected then the PLC commands the auger motor to turn on 89 through the VFD using a soft start and accelerating to operating speed. As a result, the VFD activates 90 a screen rotation program previously selected whether continuous, intermittent rotation or no rotation of the screen. The PLC activates a timed interval cleaning cycle in step 91. As a result, 92 the auger motor reduces speed, the screen motor turns on (if not previously on) increases speed, the spray wash turns on, and the cycle runs for predetermined duration then returns to normal operation at step 86.

If however, there was a fault detected at step 88 then the PLC determines 93 if there was an overload fault on the motor. If there was no overload fault, then the PLC shuts the system down 94 and sends an alarm signal. Consequently, an operator resolves the fault 95 and resets alarms and returns to the initial power on state at step 80. If there was an overload fault on the motor at step 93, then the auger motor decelerates 96, stops then reverses for a set duration for a set speed, motor decelerates stops then accelerates forward. The PLC determines 97 next whether or not the maximum interval has been exceeded. If not, then the process returns to polling whether or not a fault has been detected at step 88. However, if the maximum interval has been exceeded then the process proceeds to step 94 where the PLC shuts the system down 94 and sends an alarm signal and proceeds down that branch.

The first embodiment covers the basics of the core invention. The second embodiment is beneficial because it allows one press to service multiple filters which could save space, capital cost and energy consumption. The third embodiment eliminates the recirculation only to prevent limitations by requiring recirculation which is superior. The fourth embodiment adds the recirculation; gravity dropping into the press saves the cost of requiring additional conveying equipment. The fifth embodiment is to cover situations where gravity flow is not possible; however, this is not currently common since in this model an automated liquid solid separator and press are integral; however, if the press is used with another type of automated liquid solid separator, such as a vibratory screen, gravity dropping into the hopper may not be feasible. This embodiment also eliminates the recirculation to avoid being limiting. Finally, the sixth embodiment adds the recirculation.

The Variable Frequency Drive is a component that is attached to a motor such as 3 phase motor for running various speed therewith; thus, the VFD can provide a soft start (slower than w/o a VFD) so that the motor does not have unwanted operational problems during startup. The normal operation of the Dewatering Systems herein has the auger motor rotating at about 22 rpms whilst the screen cylinder motor rotates at about 1-2 rpms. In order to simulate a faster screw tip the VFD operates the screw motor at about 20 rpms counterclockwise whilst the cylinder screen motor operates at 10 rpms clockwise thereby simulating an increasing speed of the screw tip.

It should be understood that VFD is a Variable Frequency Drive controller that has the general capabilities of variable speed control (-ler) for three phase electric motors and may also have the capability to reverse polarity and run a motor forward and backwards. VFDs are specific to 3 phase motors, and it should be understood that other types of speed controllers are available that achieve similar results for different motor configurations. The cylinder screen motor has this electronic speed controller component attached thereto for the above mentioned reasons. The auger screw motor may or may not have speed control installed as the system can function with or without the auger screw having speed control. It should also be understood that the word Speed Controller in the specification is to a more specific item that has this specific function but could also have other types of functions.

Within the specification, the word ‘drive’ is a general term that doesn't necessarily imply an electric motor. For example, you could have an engine drive, a pneumatic drive, an electric motor, a steam turbine etc. Herein, the term variable frequency drive (VFD) is more formally a variable frequency drive controller; this is associated specifically with 3 phase electric motors and the variable frequency drive controller is a speed controller. Other types of speed controllers could be used within the inventive concepts described herein as a substitute for the VFD for single phase motors, such as a rheostat that controls speed by varying the resistance, i.e. ceiling fans.

Other considerations: A) The auger screw drive assembly 8 is most generally a motor whilst the cylinder screen drive assembly 12 is most generally a motor and speed controller. However, various other systems/components can be optionally included in the above assemblies as described in other parts of the specification. B) It should be understood that the gear reducer is an optional part of the drive assembly and that the gear reducer could be coupled with an engine, a turbine or any other drive mechanism. D) Common nomenclature is direct drive versus indirect drive. For example, the teachings herein describe the auger screw drive as a direct drive because the motor assembly couples directly to the auger screw and thereby literally turns the auger screw. This of course could easily be adapted to an indirect drive by mounting of the motor somewhere else and coupling them together with a belt or other known system. On the other hand, the screen drive is an indirect drive because the motor is mounted to a support and the belt couples the motor through more gears/pulleys. D) Finally in the specification and sketches, a gear reducer and a VFD are shown as separate components. Some expensive motors are designed so that the motor drive controller is integral with the motor and the torque and speed can both be controlled in such a wide range that no gear reducer is necessary.

The above-described embodiments are merely exemplary illustrations of implementations set forth for a clear understanding of the principles of the invention. Many variations, combinations, modifications or equivalents may be substituted for elements thereof without departing from the scope of the invention. Therefore, it is intended that the invention not be limited to the particular embodiments disclosed as the best mode contemplated for carrying out this invention, but that the invention will include all the embodiments falling within the scope of the appended claims.

What is claimed is:

1. A dewatering system comprising:
a collection hopper receiving a liquid solid mixture wherein the collection hopper has a screw inserted within a bottom portion thereof, wherein the bottom portion forms a trough;
a first motor external to collection hopper actuating the screw; wherein the screw conveys material to a cylindrical screen disposed within an adjacent press container;
a screw tip is attached to the screw at a connection such that the screw tip terminates inside of the cylindrical screen at an adjustable location in an axial direction within the cylindrical screen; wherein the connection permits adjustments in an overall length of the screw and screw tip thereby changing a size of a compaction zone within the cylindrical screen;
a set of rollers supporting the cylindrical screen, wherein the rollers are attached to the adjacent press container such that the rollers permit rotation of the cylindrical screen but forbids motion longitudinally or laterally;
a second motor supported on top of the press container such that the second motor is rotationally coupled to the cylindrical screen; and
a speed controller associated with the second motor of the cylindrical screen capable of varying the speed of the cylindrical screen.

2. The dewatering system of claim 1, further comprising:
a stationary brush attached to the press container such that the stationary brush comes into contact with a surface of the cylinder screen defined by an outside diameter thereof in order to remove excess solids from the outside diameter.

3. The dewatering system of claim 1, further comprising:
a stationary brush bracket for mounting the stationary brush such that the stationary brush bracket is bolted to the outside of the press container and protrudes inside the container thru holes in the press container so that the stationary brush can be replaced with minimal disassembly.

4. The dewatering system of claim 1, further comprising:
a stationary spray wash located on the outside of the cylinder screen in association with the press container in order to remove excess solids from the outside diameter.

5. The dewatering system of claim 1, further comprising:
an outlet restriction at an exit of the press container that generates a dry cake.

6. The dewatering system of claim 1, further comprising:
one or more brushes on an auger flight of the screw tip thereby cleaning an inside diameter of the cylindrical screen.

7. The dewatering system of claim 1, further comprising:
an automated liquid solid separator deposits screened solids and any wash water associated therewith to the collection hopper;
a press filtrate sump associated with a drain of the press container;
a pump that is able to pump liquids from the sump through appropriate connection there between;
a sump level detector that sends signals to a controller capable of turning the pump on and off, wherein the pump is turned on when a high liquid level in the sump is detected and is turned off when low liquid level in the sump is detected;
wherein the pump when activated moves press filtrate back to the automated liquid solid separator through appropriate connection there between in order to be screened again.

8. The dewatering system of claim 1, further comprising: where the automated screen system is located above the dewatering device and feeds directly into the hopper by gravity.

9. The dewatering system of claim 1, further comprising: where the automated screen system discharges a liquid solid mixture to a conveyor system that conveys the mixture to a location above the dewatering device and feeds directly into the hopper.

10. The dewatering system of claim 1 further comprising: a speed controller associated with the auger screw capable of varying the speed of the auger screw.

11. The dewatering system of claim 1 further comprising: a speed controller associated with the cylindrical screen capable of reversing the direction of the cylinder screen.

12. The dewatering system of claim 1 further comprising: a speed controller associated with the auger screw capable of reversing the direction of the auger screw.

13. A dewatering system comprising:
a first motor associated with
a press container having a first motor actuated rotating cylinder screen therein, such that the press container is attached to
a hopper associated with the press container, and a second motor associated with the hopper, wherein the hopper has a second motor actuated auger screw rotationally mounted therein; wherein liquid solid materials arrive in the hopper and are processed thereby and then transported to the press container by motion of the auger screw for further processing by the rotating cylinder screen;
an automated liquid solid separator associated with the hopper such that the hopper receives liquid solid materials from the automated liquid solid separator.

14. The dewatering system of claim 13, further comprising:
a sump receiving processed effluents from a drain in the press container and recirculating the processed effluents through the automated liquid solid separator.

15. The dewatering system of claim 14, further comprising:
a pump attached to the sump whereby the processed effluents are pumped to the automated liquid solid separator.

16. The dewatering system of claim 13, further comprising:
influent raw liquid enters the automated liquid solid separator such that an effluent screened liquid exits directly therefrom.

17. The dewatering system of claim 13, further comprising:
wherein the liquid solid materials arriving in the hopper are processed thereby and transported to the press container by motion of the auger screw for further processing by the rotating cylinder screen such that liquids exit a drain in the press container to a sewer.

18. The dewatering system of claim 13, further comprising:
cake produced by the press container rotating cylinder screen from the liquid solid materials arriving in the hopper and processed thereby that have been transported to the press container by motion of the auger screw for further processing by the rotating cylinder screen, wherein the cake exits an opening in the press container.

19. The dewatering system of claim 13, further comprising:
a conveyor disposed between the automated liquid solid separator and the hopper such that conveyor transports wet solid materials above the hopper for placement therein.

20. The dewatering system of claim 19, further comprising:
a drain in the press container attached to a sump, wherein the exiting liquid solid materials are transported to the sump;
a pump attached to the sump whereby the exiting liquid solid materials are transported to the automated liquid solid separator.

21. The dewatering system of claim 19, further comprising:
a drain in the press container associated with a sewer, wherein the exiting liquid solid materials are released into the sewer.

22. The dewatering system of claim 19, further comprising:
a variable frequency drive associated with the first motor capable of speed control, motor reversing and motor load detection.

23. The dewatering system of claim 19, further comprising:
a variable frequency drive associated with the second motor capable of speed control, motor reversing and motor load detection.

24. A dewatering system comprising:
a first motor associated with
a press container having a first motor actuated rotating cylinder screen therein, such that the press container is attached to a last hopper;
a first hopper associated with the press container, and a second motor associated with the first hopper, wherein the first hopper has a second motor actuated first auger screw rotationally mounted therein; wherein liquid solid materials arrive in the first hopper and are processed thereby and then transported to the press container by motion of the auger screw for further processing by the rotating cylinder screen;
one or more other auger screws connected sequentially to the first auger screw wherein the one or more other auger screws are each situated within a single one of one or more other hoppers attached together sequentially; and
an auger tip attached to a last auger screw in the sequence wherein the auger tip is situated in the last hopper, such that there is at least one more sequentially attached hoppers than their are auger screws as the last hopper hosts the auger tip.
